(19) United States
(12) Patent Application Publication
(10) Pub. No.: US 2025/0303390 A1
(43) Pub. Date: Oct. 2, 2025

(54) CARBON-BASED ADSORBENTS FOR SELECTIVE REMOVAL OF PARAFFINS FROM LIGHT OLEFIN/PARAFFIN MIXTURES AND METHOD OF MANUFACTURING SAME

(71) Applicant: KHALIFA UNIVERSITY OF SCIENCE AND TECHNOLOGY, Abu Dhabi (AE)

(72) Inventors: Fahmi Anwar, Abu Dhabi (AE); Georgios N. Karanikolos, Abu Dhabi (AE); Maryam Tariq Ahmed Khaleel, Abu Dhabi (AE); Kean Wang, Abu Dhabi (AE); Anish Mathai Varghese, Abu Dhabi (AE); Suresh Kumar Reddy Kuppireddy, Abu Dhabi (AE)

(73) Assignee: KHALIFA UNIVERSITY OF SCIENCE AND TECHNOLOGY, Abu Dhabi (AE)

(21) Appl. No.: 18/736,636

(22) Filed: Jun. 7, 2024

(30) Foreign Application Priority Data
Apr. 1, 2024 (GR) 20240100230

(51) Int. Cl. B01J 20/20; B01J 20/28; B01J 20/30; B01J 20/32; B01J 20/34; C01B 32/194; C01B 32/198; C01B 32/23; C01B 32/354

(52) U.S. Cl. CPC B01J 20/205; B01J 20/28061; B01J 20/28064; B01J 20/28066; B01J 20/28071; B01J 20/28073; B01J 20/28083; B01J 20/3071; B01J 20/3078; B01J 20/3204; B01J 20/3234; B01J 20/3416; B01J 20/3458; C01B 32/194; C01B 32/198; C01B 32/23; C01B 32/354; C01B 2204/32; C01P 2002/72; C01P 2002/82; C01P 2002/88; C01P 2004/03; C01P 2004/04; C01P 2006/12; C01P 2006/14; C01P 2006/16

(57) ABSTRACT

The present disclosure relates to functionalized carbon-based adsorbents for use in selective removal of paraffin impurities from a light paraffins/olefins mixture, in particular at ambient/normal conditions of temperature and pressure. The carbon-based adsorbent comprises a carbonaceous based material functionalized at least in part on active sites thereof with functional groups configured to selectively adsorb the light paraffins from the mixture, thereby resulting in a purity of at least 99.9% of the light olefins upon separation. As described, the adsorbent may comprise activated carbon functionalized at least in part on active sites thereof with fluorine functional groups. Alternatively, the adsorbent may comprise reduced graphene oxide having at least in part on active sites thereof oxygen groups. Methods for manufacturing the absorbents and use them are also disclosed.

### CROSS-REFERENCE TO RELATED APPLICATIONS

This application claims priority to Greek patent application having application No. 20240100230 filed on Apr. 1, 2024, all of which is incorporated herein by reference.

### FIELD

The present disclosure relates to functionalized carbon-based adsorbents for use in selective removal of paraffin impurities from a light paraffins/olefins mixture and methods for manufacturing same.

### BACKGROUND

Light olefins are components of major importance in the chemical industry. Ethylene (C₂H₄), for example, is a major feedstock in the petrochemical industry that is produced primarily from naphtha with trace amounts of ethane (C₂H₆) as impurity. One of the seven most important separation processes in the industrial world in terms of required energy and market value is the separation of light olefins from undesirable paraffin molecules as indicated by Sholl and Lively “Seven chemical separations to change the world”, Nature volume 532, pages 435-437 (2016) the entire publication is incorporated herein by reference.

While cryogenic separation (i.e. distillation) of ethane, as an impurity, from an ethylene stream is a well-established process, due to the tremendous energy requirements in cryogenic separation of light olefin/paraffin mixtures, energy-saving alternative separation technologies, such as adsorption, are highly demanded.

Several classes of porous adsorbents, primarily composed of Metal-Organic Frameworks (MOFs), have been reported to exhibit high C₂H₆/C₂H₄ separation properties, yet mainly via selectively adsorbing the olefin compound i.e. ethylene (Anwar, F.; Khaleel, M.; Wang, K.; Karanikolos, G. N. Selectivity Tuning of Adsorbents for Ethane/Ethylene Separation: A Review. Ind. Eng. Chem. Res. 2022).

In addition to high separation efficiency, adsorbent moisture stability is critical for performance, as the industrial feed following naphtha cracking typically contains traces of moisture, typically <1 ppm (Wang, Y.; Peh, S. B.; Zhao, D. Alternatives to Cryogenic Distillation: Advanced Porous Materials in Adsorptive Light Olefin/Paraffin Separations. Small 2019, 15 (25), 1-38). Another crucial factor in adsorbent performance is regenerability meaning that the adsorbent could be repeatedly used after regeneration and gaining its initial or near initial adsorption capacity.

U.S. Pat. No. 8,017,825 B2 reported modified Na-ETS-10 zeolite for selective uptake of ethylene from an ethylene/ethane mixture. Modification with Ba⁺ and Ba/H⁺ provided modified ETS-10 zeolite adsorbents a good balance of selectivity and pressure swing capacity for the separation of ethylene/ethane mixtures, making them promising adsorbents for Pressure Swing Adsorption (PSA) processes. Cationically modified ETS-10 zeolite had an ethylene capacity of 1.0 mmol/g at 298 K and 1 bar resulting from the x-complexation interactions between the metal ions and C₂H₄ molecules.

Patent document CN109651055B discloses an ultra-micropore anion pillared hybrid MOF exhibiting ethylene-selectivity. Both thermodynamic and kinetic uptakes were higher for ethylene than for ethane arising from the molecular sieving mechanism of the adsorbent with the tailored-made pores. Similarly, in the patent document CN108014752B, alkaline-earth metal-based MOF was reported with an ethylene/ethane IAST selectivity as high as 55. The adsorbent also demonstrated notable breakthrough separation performance with a time difference of 24 minutes between the elution of two gases from the packed bed. All these reported patents were focused on ethylene-selective adsorbents demanding substantial energy, large units and high amount of active adsorbent to achieve high-purity ethylene, in contrast to our energy-efficient technology based on ethane-selective adsorbents.

Most of the state of the art adsorbents are olefin-selective. However, as the industrial feed is olefin-rich, developing a paraffin-selective adsorbent is advantageous in terms of energy and processability. Thus, paraffin-selective adsorbents are under intense exploration. As one example, MOF-841 has been reported to exhibit a high C₂H₆ uptake of 4.7 mmol/g of adsorbent at 298 K and 1 bar resulting from the synergetic effects of the C—H . . . π and C—H . . . O interactions between the framework and C₂H₆ molecules (Jiang, S.; Guo, L.; Chen, L.; Song, C.; Liu, B.; Yang, Q.; Zhang, Z.; Yang, Y.; Ren, Q.; Bao, Z. A Strongly Hydrophobic Ethane-Selective Metal-Organic Framework for Efficient Ethane/Ethylene Separation. Chem. Eng. J. 2022, 442 (PI), 136152). Likewise, a Ni-based MOF synthesized with a mixture of two ligands, demonstrated a C₂H₆ uptake of 3.36 mmol/g at similar conditions, due to the specific interactions between C₂H₆ molecules and methyl groups from the ligand (Zhang, J.; Liu, Z.; Liu, H.; Xu, F.; Li, Z.; Wang, X. Preferential Adsorption Performance of Ethane in a Robust Nickel-Based Metal-Organic Framework for Separating Ethane from Ethylene. ACS Omega 2022, 7 (9), 7648-7654).

In parallel, the enhanced van der Waal's interactions of C₂H₆ with alkyl groups resulted in a C₂H&/C₂H₄ selectivity of 2 at 298 K and 1 bar on a MOF bearing dense alkyl groups (Jiang, Y.; Jia, S.; Liu, X.-Q.; Cui, P.; Sun, L.-B. Selective Adsorption of Ethane over Ethylene through a Metal-Organic Framework Bearing Dense Alkyl Groups. Sep. Purif. Technol. 2022, 295 (April)). An Al-based MOF with good moisture stability was reported to have notable breakthrough separation of C₂H₆/C₂H₄ mixture with more than 20 min of time difference between the elution of the two gases through the adsorption column (Laha, S.; Dwarkanath, N.; Sharma, A.; Rambabu, D.; Balasubramanian, S.; Maji, T. K. Tailoring a Robust Al-MOF for Trapping C₂H₆ and C₂H₂ towards Efficient C₂H₄ Purification from Quaternary Mixtures. Chem. Sci. 2022, 13 (24), 7172-7180). While the majority of MOF adsorbents show promising selectivity, their performance is frequently hampered by moisture and chemical instability.

In this context, carbonaceous adsorbents have been investigated as more stable alternatives. Carbonaceous adsorbents such as activated carbon (AC), after proper surface tuning, can have a higher affinity for C₂H₆ than C₂H₄ molecules, as paraffin molecules are more polarizable because of their higher molecular weight. Both C₂H₆ and C₂H₄, for instance, interact with carbonyl and nitrile functional groups on the AC surface, yet C₂H₆ forms stronger bonds compared to C₂H₄, as sp³-hybridized carbon of C₂H₆ molecules interact homogenously with oxygen and nitrogen atoms present in the surface functional groups. On the other hand, the sp²-hybridized carbon atoms in C₂H₄ interact with the surface more weakly and at a certain angle (Liang, W.; Zhang, Y.; Wang, X.; Wu, Y.; Zhou, X.; Xiao, J.; Li, Y.; Wang, H.; Li, Z. Asphalt-Derived High Surface Area Activated Porous Carbons for the Effective Adsorption Separation of Ethane and Ethylene. Chem. Eng. Sci. 2017, 162, 192-202 & Do, D. D.; Do, H. D. Effects of Potential Models on the Adsorption of Ethane and Ethylene on Graphitized Thermal Carbon Black. Study of Two-Dimensional Critical Temperature and Isosteric Heat versus Loading. Langmuir 2004, 20 (25), 10889-10899).

A chitosan-derived carbon adsorbent was reported to have high C₂H₆ uptake of 7.5 mmol/g at 298 K and I bar owing to the customized pore windows obtained by the introduction of —NH₂ functional sites into the pore channels, These carbonized adsorbents exhibited higher affinity for C₂H₆ than C₂H₄ molecules, as paraffin molecules are more polarizable because of their higher molecular weight (Mu, X. T.; Ouyang, Y. S.; Pei, L. M.; Peng, Z. X.; Shao, S. Q.; Wang, S. M.; Xiong, H.; Xiao, Y.; Yang, Q. Y. Control of Pore Environment in Highly Porous Carbon Materials for C₂H₆/C₂H₄ Separation with Exceptional Ethane Uptake. Mater. Today Chem. 2022, 24, 1-9).

Polydopamine-based carbon was observed to be C₂H₆-selective owing to the van der Waal's interactions between the surface and the more polarizable C₂H₆ molecules. The sp² hybridized carbon atoms in C₂H₄ interact with the surface weakly and at a certain angle compared to the C₂H₆ molecules, which forms stronger bonds, as sp³ hybridized carbon of C₂H₆ molecules interacts homogenously with oxygen and nitrogen atoms present in the surface functional groups. The selectivity of these adsorbents was lower than that of the adsorbents we had developed here. For instance, at 1 bar and 298 K, we obtained ethane-ethylene selectivity of 6.1 and 3.8, for the first and second types of carbon-based adsorbents respectively (Wang, X.; Wu, Y.; Zhou, X.; Xiao, J.; Xia, Q.; Wang, H.; Li, Z. Novel C-PDA Adsorbents with High Uptake and Preferential Adsorption of Ethane over Ethylene. Chem. Eng. Sci. 2016, 155, 338-347).

Studies on biomass-processed adsorbents were investigated by utilizing organic molecules such as glucose and fructose to subsequently develop carbonaceous adsorbents with high C₂H₆ uptake (Ma, C.; Wang, X.; Wang, X.; Yuan, B.; Wu, Y.; Li, Z. Novel Glucose-Based Adsorbents (Glc-As) with Preferential Adsorption of Ethane over Ethylene and High Capacity. Chem. Eng. Sci. 2017, 172, 612-621 & Xiao, H.; Wu, Y.; Wang, X.; Peng, J.; Xia, Q.; Li, Z. A Novel Fructose-Based Adsorbent with High Capacity and Its Ethane-Selective Adsorption Property. J. Solid State Chem. 2018, 268 (September), 190-197). The abundant micro-pores in the glucose-derived carbon, alongside the existence of oxygen functional groups inside the pores, resulted in a C₂H₆ capacity of 7.98 mmol/g at 288 K and 1 bar. Molecular simulation studies also revealed that fructose-derived carbon possessed multiple active sites such as C-sp² site of aromatic carbon ring and furan oxygen site, on the surface with higher binding energy for C₂H₆ than C₂H₄, leading to favorable adsorption of paraffin.

While the above studies suggest that carbon-based materials are promising in C₂H₆/C₂H₄ separation and have demonstrated notable C₂H₆ capacity and selectivity, their selectivity remains too low to be applied on an industrial scale and meet the produced olefin purity targets. Therefore, there is a need for new carbonaceous (also interchangeably known as carbon-based) adsorbents that i) have selectivities that are high enough to be applied at industrial scale, ii) are operable at temperatures not as low as cryogenics and closer to ambient temperatures, iii) have the capability of being regenerated and iv) preferably have high moisture stability.

### SUMMARY

This Summary is provided to introduce a selection of concepts in a simplified form that are further described below in the Detailed Description. This Summary is not intended to identify key aspects or essential aspects of the claimed subject matter.

Broadly stated, in some embodiments, the present disclosure relates to a carbon-based adsorbent for separation and removal of light paraffins from light paraffins/olefins mixtures that substantially comprises light olefins and at ambient/normal conditions of temperature and pressure, the carbon-based adsorbent comprising a carbonaceous based material functionalized at least in part on active sites thereof with functional groups configured to selectively adsorb the light paraffins from the mixture, thereby resulting in a purity of at least 99.9% of the light olefins upon separation.

In some embodiments, the carbon-based adsorbent may include one or more of the following features:
the carbon-based adsorbent is configured to be used for the separation of light paraffins from the light paraffins/olefins mixture at a temperature ranging from about 263 K to about 298 K and at a pressure of up to about 1 bar, preferably at about 298 K and 1 bar so that extra energy is not required for heating/cooling and/or compression/decompression.
the adsorbent has a kinetic selectivity of about 2.4 at 298 K and 1 bar.
the adsorbent has an IAST selectivity ranging from about 2.38 to about 6.1 at 298 K and 1 bar.
the adsorbent has a breakthrough selectivity ranging from about 2 to about 2.64 at 298 K and 1 bar.
the adsorbent has a paraffin adsorption capacity ranging from about 1.17 mmol/g to about 3.1 mmol/g at 298 K and 1 bar.
the carbonaceous base comprises reduced graphene oxide, or the carbonaceous base comprises activated carbon and the functional groups comprise fluorine.
the light paraffins are ethane and the light olefins are ethylene.
the adsorbent is regenerable.
the adsorbent allows for multiple regeneration cycles while maintaining substantially a same adsorption capacity, wherein the multiple regeneration cycles are performed via vacuum in the absence of thermal energy input, or at ambient pressure by purging with inert gas.

Broadly stated, in some embodiments, the present disclosure relates to an activated carbon based adsorbent for separation and removal of light paraffins from a light paraffins/olefins mixture that substantially comprises the light olefins at ambient/normal conditions of temperature and pressure, the adsorbent comprising activated carbon functionalized at least in part on active sites thereof with fluorine functional groups, wherein the adsorbent is configured to selectively adsorb the light paraffins from the mixture thereby resulting in a purity of 99.9% of the light olefins upon separation.

In some embodiments, the activated carbon based adsorbent may include one or more of the following features:
the carbon-based adsorbent is configured to be used for the separation of the light paraffins from the light paraffins/olefins mixture at a temperature range from about 263 K to about 298 K and at a pressure of about 1 bar, preferably at about 298 K and 1 bar so that extra energy is not required for heating/cooling and/or compression/decompression.
the adsorbent has a BET surface area ranging from about 448 m²/g to about 1220 m²/g.
the adsorbent has a total pore volume from about 0.44 cm³/g to about 0.79 cm³/g.
the adsorbent has an average pore size from about 2.58 nm to about 3.95 nm.
the adsorbent has a light paraffins adsorption capacity ranging from about 1.79 mmol/g of adsorbent to about 3.1 mmol/g of adsorbent at 298 K and 1 bar.
the adsorbent has a selectivity ranging from about 1.1 to about 3.9 at 298 K and 1 bar.
the adsorbent has an IAST selectivity ranging from about 2 to about 6.1 at ambient conditions of about 298 K and about 1 bar for the light paraffins/olefins mixture having a volumetric ratio of 1:15.
the adsorbent has a breakthrough selectivity of about 2.64 at 298 K and 1 bar for the light paraffins/olefins mixture having a volumetric ratio of 1:9.
the adsorbent has a kinetic selectivity of about 2.4 at 298 K and 1 bar.
the light paraffins are ethane and the light olefins are ethylene.

Broadly stated, in some embodiments, the present disclosure relates to a method of manufacturing an activated carbon based adsorbent for separating light from a light paraffins/olefins mixture that substantially comprises light olefins, the method comprising:
mixing a given amount of activated carbon with an acidic solution comprising a given amount of sodium fluoride to obtain a biphasic mixture wherein a mass ratio of the activated carbon to the sodium fluoride ranges from about 10 to about 50;
filtering the biphasic mixture to obtain a solid phase;
washing the solid phase;
drying the solid phase; and
heating the dried solid phase under inert atmosphere to obtain the activated carbon based adsorbent.

In some embodiments, the method may include one or more of the following features:
the mixing is performed by sonication, preferably for about 30 min.
the washing step is performed with an aqueous solution comprising water, preferably DI water and more preferably DI water and ethanol.
the drying step is performed at a temperature of about 80° C.
the heating step is performed under inert gas atmosphere at 300° C., preferably for about 2 hours.

Broadly stated, in some embodiment, the present disclosure relates to a carbon based adsorbent for separation of light paraffins from a light paraffins/olefins mixture that substantially comprises the light olefins at ambient/normal conditions of temperature and pressure, the adsorbent comprising reduced graphene oxide having at least in part on active sites thereof oxygen groups configured to selectively adsorb the light paraffins from the mixture thereby resulting in a purity of 99.9% of the light olefins upon separation.

In some embodiments, the carbon based adsorbent may include one or more of the following features:
the carbon-based adsorbent is configured to be used for the separation of the light paraffins from a light paraffins/olefins mixture at a temperature range from about 263 K to about 298 K and a pressure of about 1 bar, preferably at about 298 K and about 1 bar so that extra energy is not required for heating/cooling and/or compression/decompression.
the adsorbent has a light paraffins capacity of 1.17 mmol/g of adsorbent at 298 K and 1 bar.
the adsorbent has a selectivity of about 1.6 at 298 K and 1 bar.
the adsorbent has a kinetic selectivity of about 2.4 at 298 K and 1 bar.
the adsorbent has an IAST selectivity of about 3.8 at 298 K and 1 bar for the light paraffins/olefins mixture having a volumetric ratio of 1:15.
the adsorbent has a breakthrough selectivity of about 2 at 298 K and 1 bar for the light paraffins/olefins mixture having a volumetric ratio of 1:9
the light paraffins are ethane and the light olefins are ethylene.

Broadly stated, in some embodiments, the present disclosure relates to a method of manufacturing an adsorbent for separation of light paraffins from a light paraffins/olefins mixture that substantially comprises the light olefins, the method comprising:
Preparing or providing a given amount of graphene oxide;
mixing the given amount of graphene oxide with water thereby obtaining a graphene oxide suspension;
adding a given volume of a reducing agent to the graphene oxide suspension to obtain a mixture; and
heating the mixture under pressure in the presence of reducing agents to obtain reduced graphene oxide forming the adsorbent.

In some embodiments, the method may include one or more of the following features:
a ratio of reducing agent to the mass of graphene oxide is about 1 μl/3 mg.
the reducing agent is selected from the group consisting of hydrazine hydrate, ethylene glycol and ethylene diamine, preferably hydrazine hydrate.
the heating step is performed under autogenous pressure in the presence of the reducing agents at 160° C., preferably for about 4 hours.

All features of exemplary embodiments which are described in this disclosure and are not mutually exclusive can be combined with one another. Elements of one embodiment can be utilized in the other embodiments without further mention. Other aspects and features of the present invention will become apparent to those ordinarily skilled in the art upon review of the following description of specific embodiments in conjunction with the accompanying Figures.

### BRIEF DESCRIPTION OF THE DRAWINGS

A detailed description of specific exemplary embodiments is provided herein below with reference to the accompanying drawings in which:

FIG. 1A is a 2D demonstration of the structure of graphene oxide and reduced graphene oxide sheets with bright dots being oxygen functional group.

FIG. 1B is a demonstration of the structure of fluorine-functionalized activated carbon (AC).

FIG. 2A is the X-ray diffraction pattern of reduced graphene oxide in accordance with a first embodiment of the present invention.

FIG. 2B is the FTIR spectra of reduced graphene oxide in accordance with a first embodiment of the present invention.

FIG. 2C is the Raman spectra of reduced graphene oxide in accordance with a first embodiment of the present invention.

FIG. 2D is the thermogravimetric analysis of reduced graphene oxide in accordance with a first embodiment of the present invention.

FIG. 2E shown Scanning Electron Microscopy (SEM) images of Graphene Oxide (GO) and reduced Graphene Oxide (rGO) in accordance with a first embodiment of the present invention.

FIG. 3A is the X-ray diffraction pattern of fluorine-functionalized activated carbon in accordance with a second embodiment of the present invention.

FIG. 3B is the FTIR spectra of fluorine-functionalized activated carbon in accordance with a second embodiment of the present invention.

FIG. 3C is the Raman spectra of fluorine-functionalized activated carbon in accordance with a second embodiment of the present invention.

FIG. 3D is the thermogravimetric analysis of fluorine-functionalized activated carbon in accordance with a second embodiment of the present invention.

FIG. 3E is the Scanning Electron Microscopy (SEM) images of fluorine-functionalized activated carbon in accordance with a second embodiment of the present invention.

FIG. 4 is a diagram of the N₂ adsorption-desorption isotherms taken at cryogenic conditions (77 K) of fluorine-functionalized activated carbon in accordance with a second embodiment of the present invention for determination of surface area.

FIG. 5 illustrates adsorption capacity of graphene oxide (GO) and reduced graphene oxide (rGO) at 298 K in accordance with a first embodiment of the present invention and as a function of pressure.

FIGS. 6A-B illustrate adsorption capacity of different reduced graphene oxide (rGO) adsorbents at 298 K, in accordance with a first embodiment of the present invention, that have been reduced with various reducing agents over different reduction times.

FIG. 7 illustrates gas adsorption performance as a function of temperature for the reduced graphene oxide in accordance with an embodiment of the present invention.

FIGS. 8A-B are IAST selectivity curves for reduced graphene oxide (rGO), in accordance with a first embodiment of the present invention, subjected to two different mixtures with different C₂H₆/C₂H₄ ratios at different temperatures.

FIG. 9 is a graph showing ethane adsorption capability upon PSA cycles at 298 K and up to 1 bar of reduced graphene oxide (rGO), in accordance with a first embodiment of the present invention, subjected to multiple cycles of regeneration.

FIGS. 10A-C are deflection-distance curves evaluated by Atomic Force Microscopy (AFM) for (A) plain tip, (B) C₂H₆-coated tip, and (B) C₂H₄-coated tip upon testing samples of reduced graphene oxide (rGO), in accordance with a first embodiment of the present invention.

FIGS. 11A-C are force histograms for (A) plain tip, (B) C₂H₆-coated tip, and (C) C₂H₄-coated tip tested on samples of reduced graphene oxide (rGO) by AFM, in accordance with a first embodiment of the present invention, with histograms corresponding to FIGS. 10A-C, respectively.

FIGS. 12A-B are breakthrough curves with pure gas as well as binary real gas mixtures for reduced graphene oxide (rGO) at 298 K and 1 bar, respectively, in accordance with a first embodiment of the present invention.

FIGS. 13A-B are adsorption isotherms of C₂H₆ and C₂H₄ at three different temperatures, and experimental C₂H₆/C₂H₄ selectivity of pure activated carbon in accordance with a second embodiment of the present invention.

FIGS. 14A-B are adsorption isotherms of C₂H₆ and C₂H₄ and experimental C₂H₆/C₂H₄ selectivity at 298 K for fluorine-functionalized activated carbon (with different levels of fluorine loading) in accordance with a second embodiment of the present invention.

FIGS. 15A-B are adsorption isotherms of C₂H₆ and C₂H₄ and experimental C₂H₆/C₂H₄ selectivity at different temperatures for AC-F-15 in accordance with an embodiment of the present invention.

FIGS. 16A-B are estimated IAST selectivities for AC-F-15, in accordance with an embodiment of the present invention, at different temperatures when subjected to a stream of C₂H₆/C₂H₄ mixture of different ratios.

FIGS. 17A-C are adsorption capacity and experimental selectivity at various temperatures, and IAST selectivity at 298 K for AC-F-20 in accordance with an embodiment of the present invention.

FIG. 18 is a graph showing ethane adsorption capacity of fluorine-functionalized activated carbon as well as C₂H₆/C₂H₄ selectivity (1/15, v/v) at 1 bar and 298 K with respect to different fluorine loadings on the activated carbon.

FIG. 19 is a graph showing ethane adsorption capability of fluorine-functionalized activated carbon, in accordance with a second embodiment of the present invention, subjected to multiple cycles of adsorption up to 1 bar and regeneration by PSA at 298 K.

FIGS. 20A-B show moisture uptake of pure activated carbon and fluorine-functionalized activated carbon at different relative pressures, and C₂H₆ uptake of fluorine-functionalized activated carbon samples at 298 K that have been subjected to moisture.

FIGS. 21A-B are single breakthrough test and cyclic breakthrough test results of AC-F-15 with a stream of C₂H₆/C₂H₄ mixture in a ratio of 1/9 (v/v) as the feed, at ambient conditions.

In the drawings, exemplary embodiments are illustrated by way of example. It is to be expressly understood that the description and drawings are only for the purpose of illustrating certain embodiments and are an aid for understanding. They are not intended to be a definition of the limits of the invention.

### DETAILED DESCRIPTION

The present technology is explained in greater detail below. This description is not intended to be a detailed catalog of all the different ways in which the technology may be implemented or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art considering the instant disclosure which variations and additions do not depart from the present technology. Hence, the following description is intended to illustrate some embodiments of the technology, and not to exhaustively specify all permutations, combinations, and variations thereof.

### Definitions

Unless defined otherwise, all technical and scientific terms used herein have the same meaning as commonly understood by one of ordinary skill in the art to which the invention pertains. Generally, the nomenclature used herein and the experiment methods which will be described later are those well known and commonly employed in the art.

The definition of main terms used in the detailed description of the invention is as follows.

As used herein, where the term “comprising” is used in the present description and claims, it does not exclude other non-specified elements of major or minor functional importance.

As used herein, the terms “including” or “having” are meant to be equivalent to “comprising” as defined above.

As used herein, the term “about” generally means within 10%, 5%, 1%, or 0.5% of a given value or range. Alternatively, the term “about” means within an acceptable standard error of the mean when considered by the person skilled in the art. Unless indicated to the contrary, the numerical parameters set forth in the present disclosure and attached claims are approximations that can vary as desired. At the very least, each numerical parameter should at least be construed in light of the number of reported significant digits and by applying ordinary rounding techniques.

As used herein, the term “at least X” refers to values above the concrete value X including the concrete value.

As used herein, the term “ambient conditions” refers to environmental conditions that correspond to different climates and primarily to temperatures ranging from about 22° C. (about 263K) to about 26° C. (about 298K) and pressures of about 1 atm or about 1 bar.

As used herein, the term “gas uptake” refers to amount of a specific gas that is adsorbed by the adsorbent and may vary with variations in temperature and pressure. In the context of the present disclosure, gas uptake is expressed as mmol of the adsorbed gas per gram of the adsorbent (mmol/g).

As used herein, the term “selectivity” refers to a key metric that quantifies the efficacy of any adsorbent in mixture separations. The experimental selectivity can be expressed as the ratio of the respective pure gas capacities (ideal selectivity) or as the real mixture selectivity. It is also common practice to use ideal adsorbed solution theory (IAST) for estimating the value of selectivity using unary isotherm data inputs. In the context of separating ethane from an ethylene/ethane mixture, the selectivity(S) of C₂H₆ over C₂H₄ can be calculated as

$$S = \frac{{x}_{ethane} / {x}_{ethylene}}{{y}_{ethane} / {y}_{ethylene}}$$

wherein xₑₜₕₐₙₑ and x_{ethylene} are the mole fraction of C₂H₆ and C₂H₄ in the adsorbed phase while yₑₜₕₐₙₑ and y_{ethylene} are their corresponding mole fraction in the gas bulk phase.

### Carbon-Based Adsorbents

The inventors in the present invention have surprisingly and unexpectedly identified carbon-based adsorbents and manufacturing method thereof that could address all the shortcomings of the previous adsorbents as set forth above. In particular, the carbon-based adsorbents according to the present invention are capable of:
efficiently separating light paraffins such as ethane from a light paraffins/olefins mixture that substantially comprises light olefins (such as ethylene) due to high selectivity for light paraffins;
providing higher uptake for light paraffins as compared to other adsorbents such as MOFs or CMS;
being used under ambient conditions and therefore results in substantially lower energy consumption;
being regenerated using vacuum or by inert gas purging at ambient pressure only (and no thermal regeneration) over multiple cycles without decrease in original capacity for light paraffins uptake; and
being used at large industrial scale without presenting moisture and/or chemical instability

Without being bound by any theory, it is believed that functionalized carbon-based adsorbents synthesized by the methods according to the present invention results in specific textures comprising active sites that have significantly higher affinity for interaction with C₂H₆ (rather than C₂H₄) which leads to a superior capability (compared to other existing adsorbents) for selective C₂H₆ uptake.

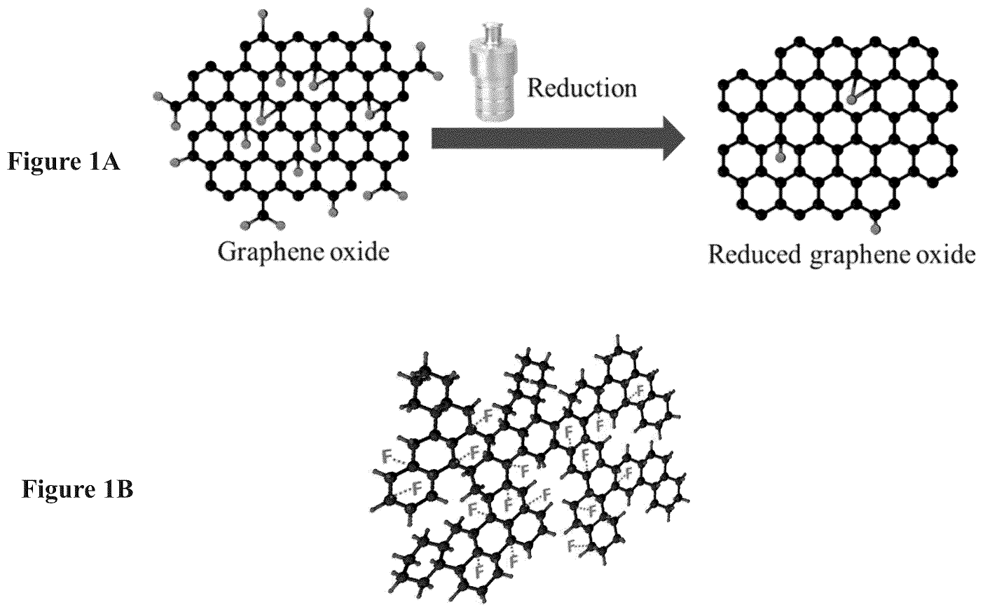

In a first embodiment according to the present invention for selective C₂H₆ separation, the carbon-based adsorbent is reduced Graphene Oxide (rGO) produced from Graphene Oxide (GO) which was in turn made of Graphene sheets. A flawless sheet of graphene contains sp² hybridized trigonally bonded carbon atoms as opposed to sp³ carbon atoms in atomically rough GO sheets. A structural illustration of Graphene Oxide (GO) and reduced Graphene Oxide (rGO) is shown in FIG. 1A wherein the bright dots are oxygen functional groups within the carbon matrix which decrease in number upon reduction.

The reduction of GO into rGO can be accomplished through a variety of methods, and the method and conditions of reduction used determine the physiochemical properties of the final product. In some embodiments, rapid heating or thermal annealing may produce rGO in large quantities. The resulting rGO product though is frequently characterized by distorted carbon planes caused by the impulsive expansion of graphene sheets. Alternatively, in another embodiment, reduction of GO into rGO may be performed by chemical reduction. Unlike thermal reduction, chemical reduction does not require a critical reaction environment and can be performed at moderate temperatures, making it more practical and affordable. In a preferred embodiment according to the present invention, the carbon-based adsorbent for use in selective ethane separation is produced by controlled hydrothermal reduction of GO with various reducing agents, including hydrazine hydrate, ethylene glycol, and ethylene diamine, to produce rGO foam adsorbents.

In a second embodiment according to the present invention for selective C₂H₆ separation, the carbon-based adsorbent is Fluorine-functionalized Activated Carbon (AC) adsorbents.

In the context of the present invention, Fluorine-functionalized Activated Carbon (AC) adsorbents are activated carbon adsorbents that are doped with fluorine atoms (i.e. elemental fluorine incorporated into the carbon matrix in activated carbon). This is shown in FIG. 1B.

In some embodiment, fluorine doping is achieved by reacting activated carbon with fluoride salt such as LiF, NaF and KF in a strong acidic medium. In a preferable embodiment, the fluoride salt is NaF.

### Examples

The Examples set forth here are related to a) Adsorbents synthesis (Examples 1-2), b) characterization (Examples 3-13) and c) Adsorbent performance (Examples 14-30)

### a) Adsorbents Synthesis

### Example 1: Reduced Graphene Oxide (rGO) Synthesis

In this example, synthesis of reduced Graphene Oxide (rGO) according to the first embodiment of the present invention is disclosed.

99.9% metal-basis natural graphite flakes (-10 mesh) from Alfa-Aesar, 99% potassium permanganate (KMn (4) from Fisher Scientific, 35% hydrogen peroxide (H₂O₂), 97% sulfuric acid (H₂SO₄,), 85% phosphoric acid (H₃PO₄), and 37% hydrochloric acid (HCl) from Merck were used for the preparation of GO. 99.8% ethylene glycol (C₂H₆O₂) and 99% ethylene diamine (C₂H₈N₂) from Merck Millipore and 99% hydrazine hydrate (H₆N₂O) from Surechem Products were used as reducing agents for the preparation of rGO.

GO was prepared by the modified Tour's method as described for example by Varghese et al. (Varghese, A. M.; Reddy, K. S. K.; Singh, S.; Karanikolos, G. N. Performance Enhancement of CO₂ Capture Adsorbents by UV Treatment: The Case of Self-Supported Graphene Oxide Foam. Chem. Eng. J. 2020, 386 (October 2019), 124022). 5 g of graphite flakes was stirred with 272 ml of H₂SO₄ for 30 minutes. After the formation of a uniform suspension, 33 ml of H₃PO₄ was added to the mixture. Successively, the KMnO₄ oxidizing agent (27 g) was added, and the reaction mixture was allowed to stir for 3 days to achieve complete oxidation. To cease the oxidation, 17.5 ml of H₂O₂ was introduced to the oxidized mixture. Following this, centrifugation was carried out to remove the supernatant acid element, and the product was washed 10 times using 1 M HCl solution. In the final step, the GO suspension was washed repeatedly with DI water, until a neutral pH was achieved. The obtained product was freeze-dried at −40° C. to obtain the final Graphene Oxide (GO).

The GO obtained as above was hydrothermally reduced using different reducing agents over different reduction times as listed in Table 1.

TABLE 1

| Sample code | Reduction time | Reducing agent | Abbreviation |
|---|---|---|---|
| rGO-4-0 | 4 | None | — |
| rGO-4-H | 4 | Hydrazine hydrate | (H) |
| rGO-12-H | 12 | Hydrazine hydrate | (H) |
| rGO-24-H | 24 | Hydrazine hydrate | (H) |
| rGO-4-EG | 4 | Ethylene glycol | (EG) |
| rGO-4-ED | 4 | Ethylene diamine | (ED) |

As for the synthesis procedure, a dispersion of GO in water (3 mg/ml) was prepared by sonication for 2 h. The desired reducing agent (1 μl for 3 mg of GO) was then added to the suspension and the mixture was then placed in a Teflon-lined autoclave at 160° C. for pre-set time. By varying the hydrothermal reaction time, a series of adsorbents were prepared, as listed in Table 1. For example, the sample rGO-4-0 refers to the rGO synthesized by the same procedure for 4 h yet without utilizing any external reducing agent. Similarly, rGO-4-H refers to the rGO synthesized by the same procedure along with Hydrazine hydrate as reducing agent for a reduction time of 4 h.

### Example 2: Fluorine-Functionalized Activated Carbon (AC) Synthesis

In this example, synthesis of Fluorine-functionalized Activated Carbon (AC) according to the second embodiment of the present invention is disclosed.

Nuchar activated carbon (AC) was obtained from MWV Specialty Chemicals. Sodium fluoride (NaF, 99.99%) and ethanol (C₂H₆O, 99%) from Sigma-Aldrich, and sulfuric acid (H₂SO₄, 97%) from Merck were used for the synthesis of the adsorbents.

As for the synthesis procedure, a fluorine-solution was prepared by dissolving 5 mg of NaF in 15 mL of 10 M H₂SO₄. Subsequently, 250 mg of Activated Carbon (AC) was added to the acid solution and sonicated for 30 min. The reaction mixture was stirred overnight at 25° C. The final product was then filtered and washed multiple times with DI water and ethanol, and dried afterward at 80° C. The adsorbent was activated by heating in a tube furnace under an N₂ atmosphere at 300° C. for 2 hours. By varying the amount of NaF in the reaction mixture, a range of samples with different fluorine loadings were synthesized as listed in Table 2.

TABLE 2

| Sample Code | Amount of NaF (mg) |
|---|---|
| AC | — |
| AC-F-5 | 5 |
| AC-F-10 | 10 |
| AC-F-15 | 15 |
| AC-F-20 | 20 |
| AC-F-25 | 25 |

### b) Characterization

### Example 3: XRD Analysis of Reduced Graphene Oxide (rGO)

In this Example, the X-ray diffraction (XRD) patterns of graphene oxide and reduced Graphene Oxide (rGO) obtained in Example 1 was performed using a Bruker D2 Phaser diffractometer in the 2θ range of 5-55° at 45 kV and 40 mA under exposure of Cu-Kα irradiation with λ=1.5406 Å (step value of 0.03° s⁻¹, and step time of 0.05 s).

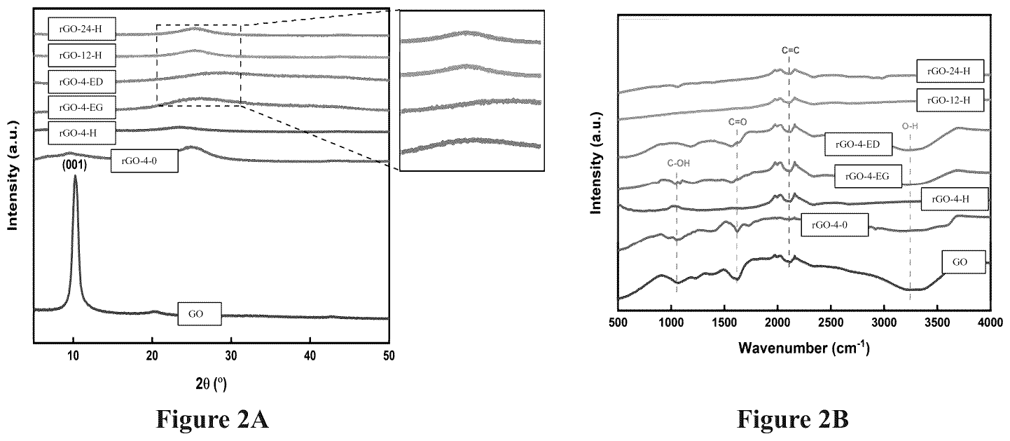

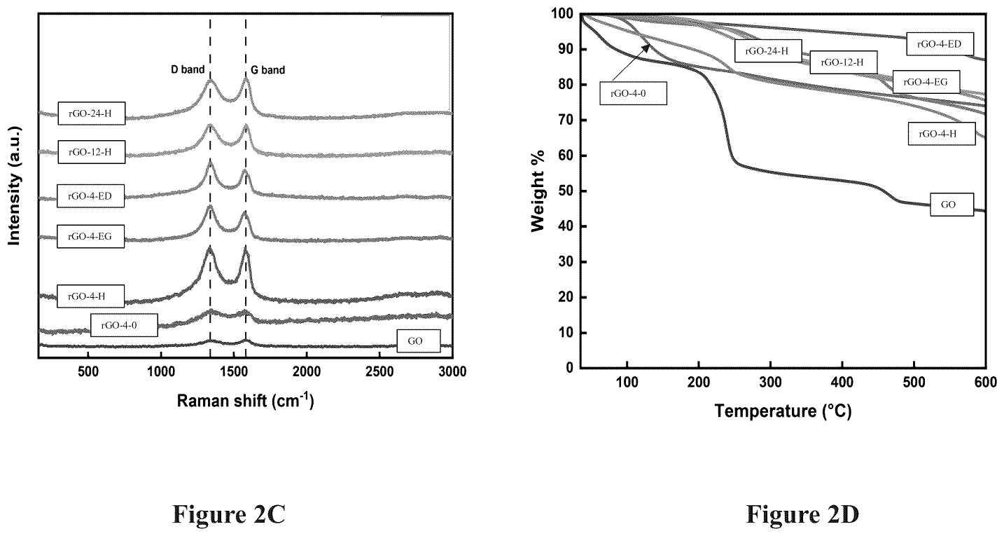

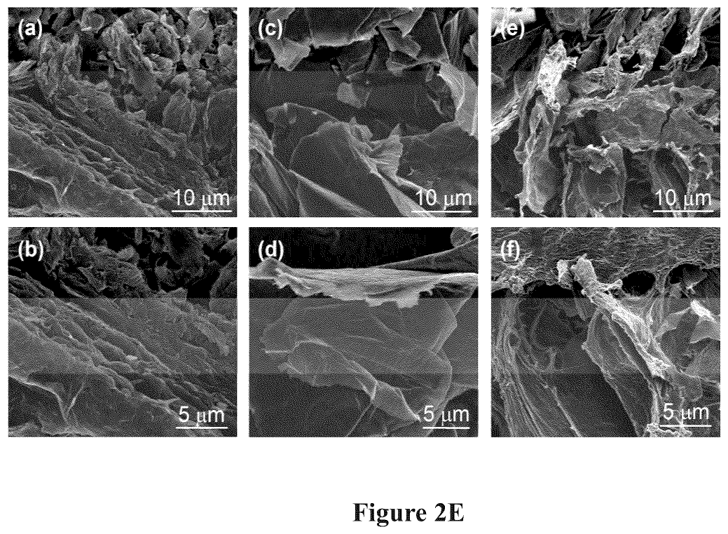

XRD patterns of the GO and rGO adsorbents are shown in FIG. 2A. The sharp peak of GO at 10° corresponds to the (001) plane, with an interlayer d spacing of 0.86 nm as estimated from Bragg's law. As evident from the obtained patterns, the characteristic GO peak disappeared for all the rGO samples, as a result of the exfoliation of the planar GO structure, while a new broad and low-intensity graphitic peak at 26° corresponding to (002) plane appeared for the rGO-4-0 partially reduced sample with a lattice d spacing of 0.29 nm. The characteristic GO peak at 10° was also observed in the same sample, yet at a significantly reduced intensity, indicating that partial reduction took place. Loss of oxygen functional groups and of adsorbed water molecules from the graphene layers upon reduction resulted in close stacking of the layers and eventually a decrease in d spacing. When reducing agents were utilized for exfoliation of graphene layers, the graphitic peak diminished for rGO-4-H, rGO-4-EG, and rGO-4-ED, whereas it reappeared for rGO-12-H and rGO-24-H when the reaction duration was increased. This is an indication of the formation of graphite-like particles when the reduction was carried out for longer periods.

### Example 4: FTIR Analysis of Reduced Graphene Oxide (rGO)

In this Example, the Fourier Transform Infrared Spectroscopy (FTIR) of reduced Graphene Oxide (rGO) obtained in Example 1 is performed. Bruker Tensor II ATR spectrometer was used to obtain (FTIR) spectra in the range of 2500-500 cm-1 to assess the changes in chemical characteristics of the prepared adsorbents. Specifically, FTIR was used to investigate the variation in oxygen functional groups present on the graphitic surface of the developed adsorbents upon hydrothermal reduction, and by inference, the degree of reduction could be assessed. For developing a highly C₂H₆-selective adsorbent, the adsorbent surface needs to be hydrophobic, devoid of polar groups such as hydroxyl groups. FIG. 2B depicts the FTIR spectra of GO and rGO samples. Various bands attributed to oxygen functionalities can be seen i.e., O—H stretching (3246 cm⁻¹), C—O vibrations (1700 cm⁻¹), and alcoholic C—OH stretching vibrations (1045 cm⁻¹) in the case of pure GO. After hydrothermal reduction, the hydroxyl peak (O—H) was partially diminished for rGO-4-0 and completely disappeared for rGO-4-H, rGO-12-H, and rGO-24-H. Likewise, the intensity of the carboxyl peak was reduced for rGO-4-EG and disappeared for rGO-4-H, rGO-12-H, and rGO-24-H. When the reducing agent was switched from hydrazine hydrate to ethylene glycol and ethylene diamine at the same reduction conditions, complete reduction was not achieved as evident from the hydroxyl peaks of rGO-4-EG and rGO-4-ED, respectively. This analysis facilitated the optimization of reduction parameters to tune the adsorption performance of the rGO samples.

### Example 5: Raman Spectroscopy of Reduced Graphene Oxide (rGO)

In this Example, the Raman Spectroscopy of reduced Graphene Oxide (rGO) obtained in Example 1 was performed and Raman spectra were obtained by Witec Alpha 300 RAS with a lateral resolution of 200-300 nm in the wavenumber range of 500-3000 cm⁻¹ at a rate of 0.76 milliseconds integration time per spectrum. The results are shown in FIG. 2C.

The D and G bands appear at 1334 and 1575 cm⁻¹, respectively, for all the samples. The D band is mainly associated with vibrations of sp′ carbon atoms with swaying bonds, indicating the presence of disordered graphene, whereas the G band corresponds to the sp² carbon, revealing the graphitic symmetry and quality of the pristine graphene. The D band intensity increases with the degree of defects, and the lowest intensity was observed for GO reflecting a low number of defects. The highest D band intensity was observed for rGO-4-H, implying the formation of structural defects between the layers resulting from the intercalation of oxygen functional groups and exfoliation upon reduction. When the reduction time was increased from 4 to 12 h, the D band intensity reduced, which can be attributed to the formation of ordered graphitic structure. When the reaction duration increased to 24 h, the intensity was further reduced suggesting the generation of better-graphitized layers. The reduction of the D band intensity in Raman spectra depends on several factors such as the degree of GO reduction, the specific reduction method used, and the reaction duration. For instance, partial reduction of graphene oxide can result in the formation of new defects, leading to an increase in the D band intensity. The I_{D}/I_{G} ratio of the samples can quantitatively reveal the degree of defects and disorder in the graphene structures. The I_{D}/I_{G} was increased from 0.92 for GO to 1.04, 1.08, 1.1, and 1.17 for rGO-4-0, rGO-4-H, rGO-4-EG, and rGO-4-ED, respectively, indicating introduction of structural defects upon reduction. However, it decreased to 0.99 and 0.94 for rGO-12-H and rGO-24-H, respectively, which is evident of the partial restoration of the lattice defects.

### Example 6: Thermogravimetric Analysis of Reduced Graphene Oxide (rGO)

In this Example, thermogravimetric analysis (TGA) of reduced Graphene Oxide (rGO) obtained in Example 1 was performed using Perkin Elmer TGA 4000 analyzer and by heating the samples from 40 to 600° C. under a continuous N₂ flow. The results are shown in FIG. 2D.

Decomposition of GO takes place in three stages, namely the loss of adsorbed moisture until 100° C., degradation of oxygen functionalities at 150-250° C., and disintegration of the carbon skeleton at 430° C. For the partially reduced sample (rGO-4-0), the weight reduction until 200° C. corresponds to the loss of residual oxygen groups, reflecting the incomplete reduction. Sample rGO-4-H was stable until 500° C. without significant mass loss, indicating the complete removal of any additional functional groups by the hydrazine hydrate reducing agent. There was no weight change detected for moisture loss, suggesting the hydrophobic nature of the material. The increase in hydrophobicity upon reduction was also confirmed by water adsorption and contact angle experiments. After 500° C., partial structural collapse and the corresponding weight loss were observed. As complete reduction was not achieved for rGO-4-ED, weight loss stages associated with moisture loss and oxygen functional groups appear in the TGA curve. The residual oxygen entities disintegrated in the range of 210-330° C. for rGO-12-H, rGO-24-H, and rGO-4-EG, whereas rGO-4-EG had an additional step of weight loss at 430-480° C. similar to pure GO.

### Example 7: Scanning Electron Microscopy (SEM) of GO and rGO

In this Example, Scanning electron microscopy (SEM) images of Graphene Oxide (GO) and reduced Graphene Oxide (rGO) obtained in Example 1, were acquired by a FEI Nova Nano SEM 650 in the range of 15-20 kV. The resulting images are shown in FIG. 2E.

Pure GO (images a and b) typically has tightly packed interlocking sheets with denser foam-like morphology, compared to the observed folded and wrinkled structure of rGO. The folding of sheets was due to the loss of oxygen functional groups upon reduction (images c and d), and the degree of folding was increased with stronger reduction conditions, such as in the case of rGO-4-H (images e and f). The sp² carbon planes are held together by weak van der Waal's forces resulting in high aggregation and a crumbled nature of rGO sheets, yet resulting in higher surface area than GO which is preferred in adsorption applications.

### Example 8: XRD Analysis of Fluorine-Functionalized Activated Carbon (AC)

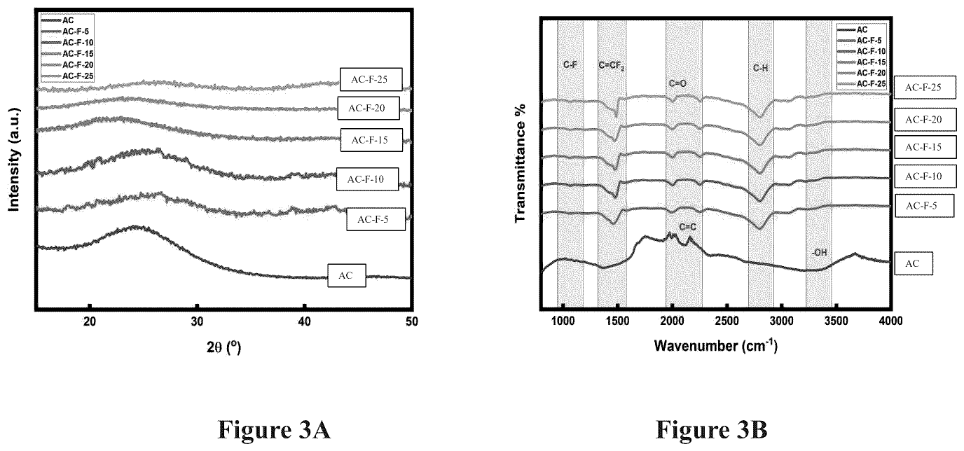

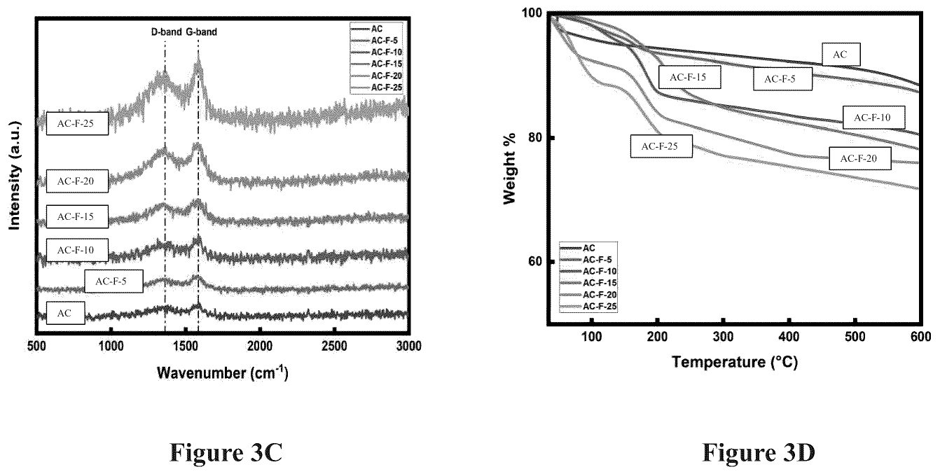

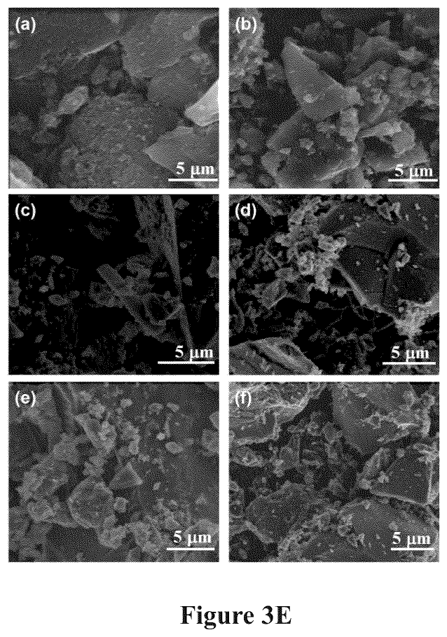

In this Example, XRD patterns of Fluorine-functionalized Activated Carbon obtained in Example 2 was obtained using a Bruker D2 Phaser diffractometer in the 20 range of 10-50° with a scan rate of 0.05° s⁻¹ (45 kV, 40 mA). The results are shown in FIG. 3A.

From XRD results, the pristine AC exhibited a broad diffraction peak at 26° assigned to the (002) plane of the amorphous carbon. Upon fluorine functionalization, the position of this peak was shifted slightly as a result of a change in the lattice structure. The fluorine atom, which is smaller than the carbon atom, when incorporated into the carbon matrix, distorted the lattice planes resulting in the peak shifting. For the samples AC-F-5, AC-F-10, and AC-F-25, a wide diffraction peak was also observed at 44° corresponding to (101) plane, formed as a result of the occurrence of new crystalline-like phases. Fluorine functionalization causes significant alteration of the carbon matrix, leading to the formation of new planes with different lattice parameters.

### Example 9: FTIR Analysis of Fluorine-Functionalized Activated Carbon (AC)

In this Example, FTIR analysis of Fluorine-functionalized Activated Carbon obtained in Example 2 was performed using a Bruker Tensor II in Attenuated total reflectance (ATR) mode in the wavenumber range of 500-4000 cm⁻¹. The results are shown in FIG. 3B.

FTIR spectroscopy was employed to comprehend the change in the functional groups present on the carbon surface upon fluorine doping. As illustrated in FIG. 3B, hydroxyl O—H stretching (3344 cm⁻¹), C—O stretching (1408 cm⁻¹), carbonyl and carboxyl C═O stretching (1904 cm⁻¹), alkenyl C═C stretching (2114 cm⁻¹), and skeletal C—C stretching (1190 cm⁻¹) were detected in the pure AC. For the functionalized samples, polarised C—F bond stretching (1067 cm⁻¹) of the tertiary carbon atom and asymmetric stretching of C═CF₂ (1485 cm⁻¹) groups located at the edges were identified, confirming the fluorination. Furthermore, the peak for aliphatic C—H (2800 cm⁻¹) stretching as well was identified for the fluorinated samples.

### Example 10: Raman Spectroscopy of Fluorine-functionalized Activated Carbon (AC)

In this Example, Raman Spectroscopy of Fluorine-functionalized Activated Carbon obtained in Example 2 was performed using a Witec Alpha 300 RAS to acquire Raman spectra in the range of 500-3000 cm⁻¹ with a laser wavelength of 532 nm. The results are shown in FIG. 3C.

All samples display two prominent peaks of the D band and G band at 1362 and 1585 cm⁻¹, respectively. The D band represents the disorder and lattice defects in the structure, whereas the G band corresponds to the ordered sp² hybridized carbon atoms. The disorder in the adsorbent structure that had undergone fluorination can be assessed by the corresponding I_{D}/I_{G} intensity ratio, whereas smaller I_{D}/I_{G} indicates a more ordered and symmetric carbon matrix. With an increase in fluorination, the D band intensity increased with a corresponding increment in I_{D}/I_{G} ratio as well, specifically from 0.97 of AC-F-5 to 0.99 of AC-F-25. This increase in the D band intensity is attributed to the introduction of defects and disorder in the carbon lattice due to the incorporation of the fluorine groups. The fluorine groups can break the symmetry of the carbon lattice, leading to the formation of new sp³ hybridized carbon atoms and the creation of defect sites. These newly formed lattice defects, however, can function as adsorption sites.

### Example 11: Thermogravimetric Analysis (TGA) of Fluorine-functionalized Activated Carbon (AC)

In this Example, Thermogravimetric Analysis (TGA) of Fluorine-functionalized Activated Carbon obtained in Example 2 was performed using a Perkin Elmer 4000 Thermogravimetric Analyzer (TGA) to study the thermal stability of the synthesized samples by heating approximately 5 mg of sample at a rate of 5° C./min under N₂ from 50 to 600° C. The results are shown in FIG. 3D.

From FIG. 3D showing the thermogravimetric profiles of the pure and fluorine-modified adsorbents, the pure AC exhibited weight loss corresponding to moisture loss up to 120° C., followed by the decomposition of the carbon skeleton starting at 500° C. On the other hand, the weight loss for the fluorine-modified samples occurred in three stages. The initial stage was due to the loss of solvent and moisture, followed by the decomposition of the organic contents, breaking of C—F bonds, and the release of C₂F₆ at 150-200° C. 39. Finally, the weight loss above 500° C. was attributed to the decomposition of the carbonaceous matrix 32. For the fluorinated samples, weight loss increased with the fluorination degree.

### Example 12: Scanning Electron Microscopy (SEM) of Fluorine-Functionalized Activated Carbon (AC)

In this Example, the morphological features of the Fluorine-functionalized Activated Carbon (AC) with varying levels of Fluorine-functionalization were investigated by SEM. Images at different magnifications were obtained at 15 kV on FEI Nova Nano SEM 650. Based on the SEM images shown in FIG. 3E, it is observed that the AC samples consist of graphitic particles/crystals with heterogeneous sizes and shapes

### Example 13: Textural and Elemental Analysis of Fluorine-Functionalized Activated Carbon (AC)

In this Example, and in the context of textural analysis, the surface area was determined using the Brunauer-Emmett-Teller (BET) model, while the pore size distribution was calculated using the Barrett-Joyner-Halenda (BJH) model. The BET analysis utilized isotherm data within the pressure range of 0.05-0.35 (p/p₀). Elemental composition was also determined by energy dispersive X-ray spectroscopy (EDS) at five different sample locations and then taking the numerical average.

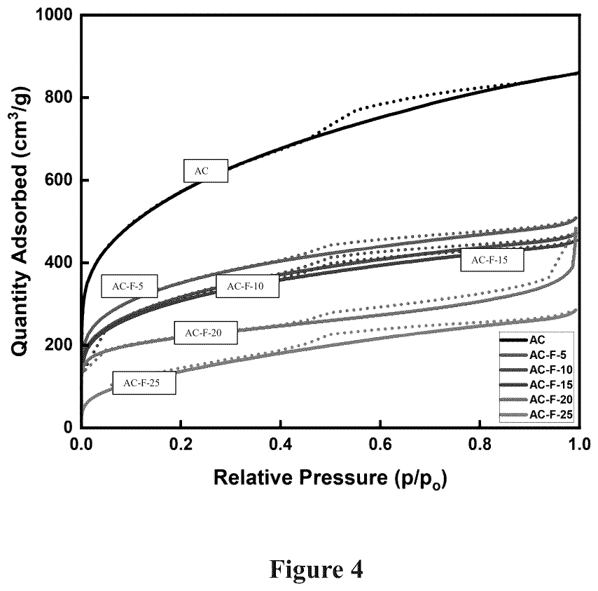

To study the textural characteristics of the samples, N₂ adsorption-desorption isotherms were measured at 77 K, as shown in FIG. 4. The acquired isotherms of all samples were observed to be of type I with a small hysteresis in the higher p/p₀ range, indicating the presence of some mesopores. When modified with fluorine, surface area as well as pore volume decreased as listed in Table 3. The BET surface area estimated for the pure AC was 1983 m²/g, which decreased gradually with the increased fluorine loading to 1220, 1102, 1071, 775, and 448 m²/g for AC-F-5, AC-F-10, AC-F-15, AC-F-20, and AC-F-25 respectively. Likewise, pure AC had a total pore volume of 1.33 cm³/g which decreased to 0.44 cm³/g for AC-F-25. This is attributed to partial blockage of the pores by the functionalization, while the increase in average pore size with the degree of functionalization indicates that the smaller microspores undergo the most severe blocking, in agreement with the reduction in N₂ uptake at the very low p/p₀ range.

As for the elemental analysis (with results included in Table 3), it was observed that with an increase in fluorine-doping, the atomic % of fluorine present in the samples increased correspondingly, confirming the presence of fluorine in the adsorbents and verifying the increasing degree of functionalization. It is noted that the F/C ratio increased from 0.0037 for AC-F-5 to 0.122 for AC-F-25. Interestingly, the oxygen content also increased significantly on the modified samples, indicating that F-doping promoted activation of the carbon so that more irregular structures were produced which host both F— and O— functional groups. Since O— also presents a strong electro-negativity, it also plays a role in enhancing the ethane selectivity.

TABLE 3

| | | Total Pore | Average | | | |
|---|---|---|---|---|---|---|
| | S_{BET} | Volume | Pore Size | C | O | F |
| Sample | (m²/g) | (cm³/g) | (nm) | (%) | (%) | (%) |
| AC | 1983 | 1.33 | 2.68 | 92.94 | 7.06 | — |
| AC-F-5 | 1220 | 0.79 | 2.58 | 90.36 | 9.3 | 0.34 |
| AC-F-10 | 1102 | 0.73 | 2.65 | 88.34 | 10.04 | 1.62 |
| AC-F-15 | 1071 | 0.71 | 2.63 | 87.3 | 10.36 | 2.34 |
| AC-F-20 | 775 | 0.65 | 3.87 | 82.08 | 11.73 | 6.19 |
| AC-F-25 | 448 | 0.44 | 3.95 | 79.86 | 10.37 | 9.77 |

### c) Adsorbent Performance.

Graphene oxide (GO) and reduced graphene oxide (rGO): The adsorption and separation performance tests for graphene oxide (GO) and reduced graphene oxide (rGO) according to the first embodiment of the present invention are as follows (Examples 14-21):

The equilibrium gas adsorption experiments were performed on a Micromeritics 3Flex Analyzer. Prior to the analysis, the adsorbents were pre-treated by heating at 363 K under vacuum. The adsorption isotherms for C₂H₆ and C₂H₄ were collected at 298 K, 283 K, and 273 K up to 1 bar. AFM Asylum MFP-3D Origin was used in the contact-mode of operation for molecular interaction analysis. Breakthrough experiments were performed on an automated breakthrough analyzer (ABR) from Hiden Isochema. The adsorbent was filled in a stainless-steel reactor column (15 cm×1 cm) and helium (150 mL/min) was purged through the packed bed for 20 min before each breakthrough run. A C₂H₆/C₂H₄ (1/9) mixture was then introduced at a rate of 5 mL/min, while the column conditions were maintained at 298 K and 1 bar. The outlet composition was determined by a single-filter, electron multiplier dynamic sampling mass spectrometer (DSMS) by Hiden Isochema with a detection range of 1-200 AMU, exhibiting a sensitivity of 100 ppb.

### Example 14: Adsorption Capacity of Graphene Oxide (GO) and Reduced Graphene Oxide (rGO)

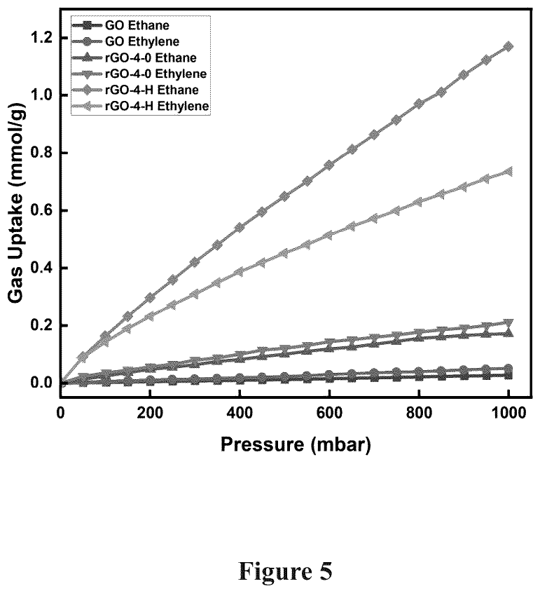

In this Example, the adsorption capacity (i.e. gas uptake) of graphene oxide (GO) and reduced graphene oxide (rGO) have been determined according to conditions specified above. The gas separation performance of the prepared samples was first analysed by volumetric equilibrium adsorption experiments using single gas streams of C₂H₆ and C₂H₄, respectively. The adsorption isotherms of pristine GO, rGO-4-0, and rGO-4-H at 298 K and pressures up to 1 bar are displayed in FIG. 5 in the form of gas uptake (mmol/g of adsorbent) vs. pressure.

According to FIG. 5, GO exhibited negligible gas adsorption capacity, with C₂H₄ uptake being slightly higher than that of C₂H₆, resulting from the interactions between the C₂H₄ molecules and the oxygen polar groups on the GO surface. When partial reduction was carried out, the uptakes were increased. Yet, the rGO-4-0 adsorbent prepared without involvement of any reducing agent was still C₂H₄-selective. When almost complete reduction was achieved by utilizing a reducing agent (rGO-4-H), the adsorbent became C₂H₆-selective and the adsorption capacity for C₂H₆ increased greatly to 1.17 mmol/g at 1 bar. Without wishing to be bound by a theory, it appears that elimination of the olefin-selective oxygen groups and exfoliation of the graphene layers cause an increase in the surface area and results in enhanced C₂H₆ adsorption capacity. In addition, the specific van der Waal's interactions of C₂H₆ molecules having sp³ hybridized carbon atoms with the carbon surface seem to have increased the paraffin selectivity, while spatial constraints arising from sp² hybridization restrict C₂H₄ molecules from developing stronger interactions with the graphene surface. The flat planar structure of C₂H₄ molecule resulting from sp² hybridization also seem to have prevented the molecule from interacting with the surface in the same way as C₂H₆, which has a tetrahedral three-dimensional arrangement.

### Example 15: effect of reduction conditions on the gas adsorption properties of reduced graphene oxide (rGO)

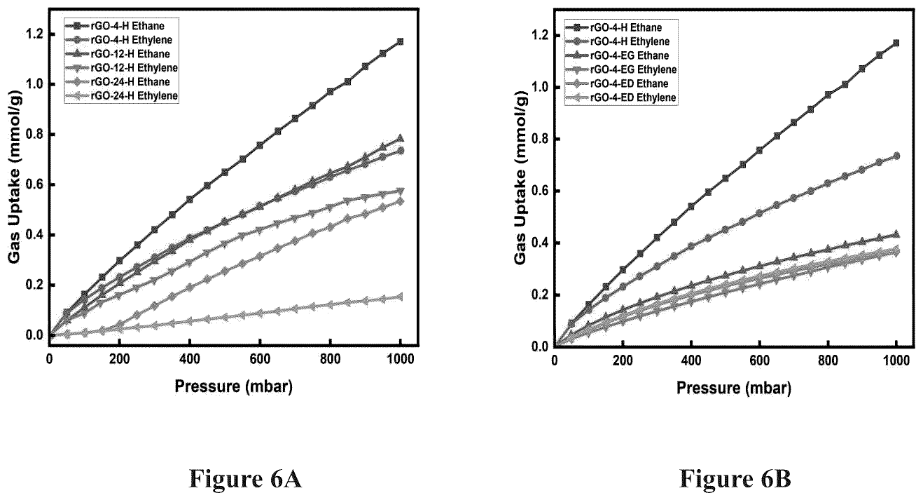

In this Example, the effect of reduction conditions on the gas adsorption properties has been evaluated by varying the reducing agent (hydrazine hydrate (H), Ethylene glycol (EG) and Ethylene diamine (ED)) and the reduction time in hours (i.e. 4H, 12H and 24H). All adsorption tests were performed at 298 K and the results are shown in FIGS. 6A and 6B.

FIG. 6A illustrates the adsorption isotherms for rGO-4-H, rGO-12-H, and rGO-24-H, which correspond to reduction time of 4, 12, and 24 h, respectively, using hydrazine hydrate as reducing agent. Though all adsorbents exhibited reverse selectivity, it is shown that with an increase in reduction time the adsorption uptakes were reduced considerably, with >50% reduction in C₂H₆ capacity for the latter sample corresponding to 24 h of reduction compared to the former one corresponding to 4-h reduction. Indeed, in rGO-24-H, the C₂H₆ uptake dropped to as low as 0.53 mmol/g at 1 bar. In fact, both C₂H₆ (0.78 and 0.53 mmol/g) and C₂H₄ (0.57 and 0.15 mmol/g) uptakes decreased for rGO-12-2 and rGO-24-2, respectively. This reduction in adsorption capacity can be ascribed to the formation of better graphitized sheets upon longer reduction duration, which was also confirmed from XRD and Raman analyses described earlier. Notably, defect sites are preferred as they constitute adsorption sites. A proper balance between removing the olefin-selective functionalities yet keeping a high density of defect sites on the surface was our target. Based on these results, for further studies, the reduction time for the samples was fixed at 4 h as an optimal one.

The type of reducing agent also significantly influences the degree of reduction and the residual oxygen functional groups present on the surface, and the mechanism of reduction considerably affects the structural and chemical properties of rGO. Larger and mechanically strong rGO flakes were reported to be obtained by chemical reduction compared to small and flaky rGO obtained by thermal reduction. FIG. 6B shows the C₂H₆ and C₂H₄ adsorption isotherms at 298 K for rGO-4-H, rGO-4-EG, and rGO-4-ED adsorbents which were reduced by employing hydrazine hydrate (H), ethylene glycol (EG), and ethylene diamine (ED), respectively, keeping the reduction duration constant. According to FIG. 6B, rGO-4-EG had a C₂H₆ capacity of only 0.43 mmol/g compared to 1.17 mmol/g of rGO-4-H at 298 K and 1 bar. This can be justified by the fact that residual functional groups still remain on the rGO surface upon treatment with ethylene glycol due to the incomplete reduction procedure, as also confirmed by FTIR. Exfoliation of the graphene layers was also inadequate for both rGO-4-EG and rGO-4-ED, thus the partial reduction compromised the adsorption capacity and C₂H₆/C₂H₄ selectivity as well. Therefore, at the given reduction conditions, hydrazine hydrate was proved to be more efficient, and hence was utilized in subsequent Examples.

### Example 16: Effect of Temperature on the Gas Adsorption Properties of Reduced Graphene Oxide (rGO)

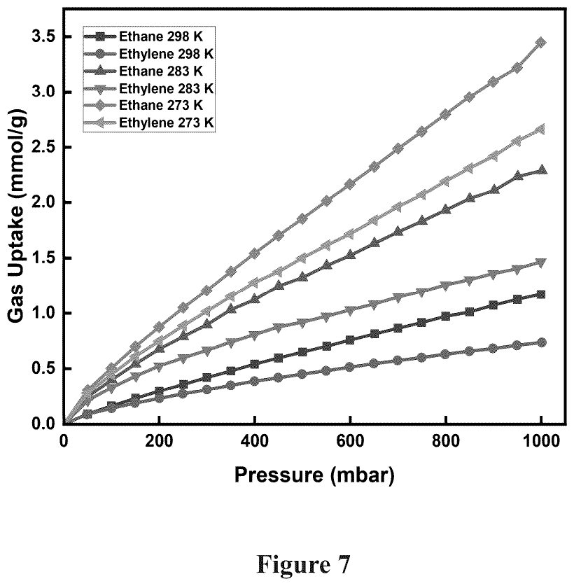

In this Example, the gas adsorption performance as a function of temperature for the rGO-4-H was explored next, i.e., at 273, 283, and 298 K and the results are shown in FIG. 7. As can be seem from FIG. 7, as temperature decreased the adsorption capacities were increased. Indeed, the C₂H₆ uptake at 298 K and 1 bar was 1.17 mmol/g and increased to 2.29 and 3.45 mmol/g at 283 K and 273 K, respectively. Similarly, C₂H₄ adsorption also increased with the decrease of temperature down to 273 K, yet higher C₂H₆ affinity on rGO-4-H at lower temperatures resulted in an enhanced C₂H₆/C₂H₄ selectivity. At 1 bar, rGO-4-H was having an experimental C₂H₆/C₂H₄ selectivity of 1.6, 1.53, and 1.32 at 298, 283, and 273 K respectively. The above observations verify the physisorption (physical adsorption) character of the developed rGO-4-H adsorbent, which is favourable for energy-efficient pressure swing adsorption (PSA) application upon regeneration.

### Example 17: Separation Performance of Reduced Graphene Oxide (rGO)

In this Example, separation performance of reduced graphene oxide (rGO) was evaluated by determining C₂H₆/C₂H₄ selectivity based on the experimental pure-gas adsorption data and the ideal adsorbed solution theory (IAST) established by Myers and Prausnitz which is known to the person skilled in the art.

The assumption that the adsorbed species form an ideal mixture was adopted, which is a widely used thermodynamic tool to predict mixture-gas selectivity. To estimate the IAST selectivity the isotherms were fitted with dual-site Langmuir (DSL) model as below (wherein where q is the amount of gas adsorbed in equilibrium with the gas phase in mmol/g, p is the equilibrium bulk gas pressure in bar, qₛ₁, and qₛ₂ are the saturation capacities, b₁ and b₂ (bar⁻¹) are the affinity coefficients of sites 1 and 2, respectively).

$$q = \frac{{q}_{s 1} {b}_{1} p}{1 + {b}_{1} p} + \frac{{q}_{s 2} {b}_{2} p}{1 + {b}_{2} p}$$

The fitted isotherms of rGO-4-H at various temperatures are shown in Table 4 below which indicate that the adsorption behaviour of C₂H₆ and C₂H₄ on the rGO samples can be predicted using the DSL model with good approximation. From Table 4, at all temperatures, the saturation uptakes (qₛ₁ and qₛ₂) for both gases increased with the decrease in temperature, while the affinity coefficients (b₁ and b₂) were higher for C₂H₆ than for C₂H₄, in agreement with the experimental results.

TABLE 4

| Adsor- | T | qₛ₁ (mmol/g) | | qₛ₂ (mmol/g) | | b₁ (bar⁻¹) | | b₂ (bar⁻¹) | |
|---|---|---|---|---|---|---|---|---|---|
| bent | (K) | C₂H₆ | C₂H₄ | C₂H₆ | C₂H₄ | C₂H₆ | C₂H₄ | C₂H₆ | C₂H₄ |
| rGO- | 298 | 3.43 | 2.31 | 2.33 | 1.08 | 0.365 | 0.086 | 0.106 | 1.11 |
| 4-H | 283 | 4.8 | 4.1 | 2.58 | 2.01 | 0.62 | 0.109 | 0.191 | 0.131 |
| | 273 | 5.8 | 4.89 | 2.72 | 2.3 | 0.617 | 0.511 | 0.563 | 0.278 |

### Example 18: Evaluation of IAST Selectivity

After the isotherm fitting, according to Example 17 above, binary gas selectivity could be calculated using the selectivity definition mentioned above. An open-source python package pyIAST was used for data converging and estimating IAST selectivity at 298, 283, and 273 K. The stated algorithm targets to equate the spreading pressure of both gases at a fixed bulk gas composition to approximate the adsorbed phase composition.

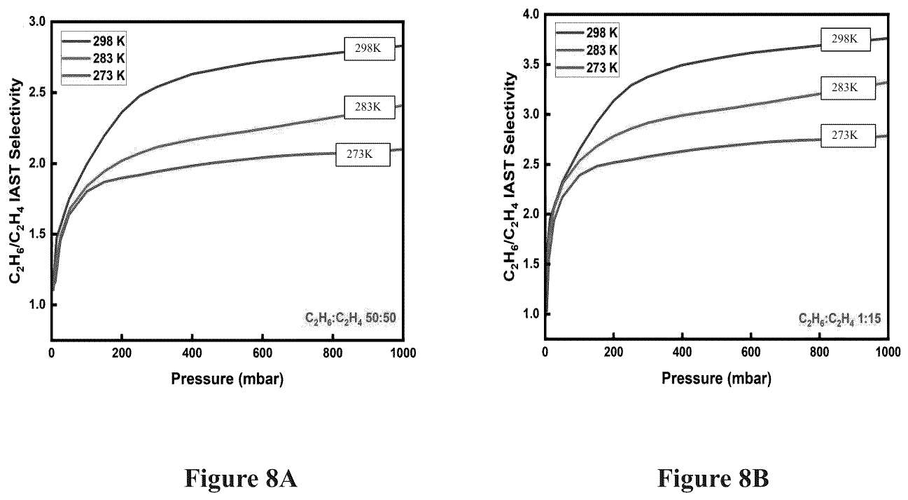

The LAST selectivity profiles determined for rGO-4-H at 298, 283, and 273 K for a paraffin/olefin stream with C₂H₆/C₂H₄ ratio of 1/15 (v/v) which is the C₂H₆/C₂H₄ ratio after naphtha cracking, and a ratio of 50/50 (v/v) are displayed in FIGS. 8A-B. The selectivity at all temperatures increased with increase in pressure and in temperature. At higher pressure, rGO exhibited higher affinity towards C₂H₆ molecules by facilitating access to adsorption sites on the exfoliated graphitic layers. Among the various adsorption temperatures, the C₂H₆/C₂H₄ selectivity was the lowest at 273 K, which indicates that the selective interactions of graphitic layers in rGO with C₂H₆ is decreased with a decrease of temperature possibly due to reduced diffusional mobility and possible restacking of graphitic layers. For 1/15 mixture, at 298 K and 1 bar, rGO-4-H had a significant C₂H₆/C₂H₄ LAST selectivity of 3.8, which was reduced to 3.3 and 2.8 at 283 and 273 K, respectively.

The obtained high selectivity value of the rGO adsorbent is compared with best-performing carbonaceous adsorbents cited in the literature, and as listed in Table 5. As can be seen, the reduced graphene oxide (rGO) according to the present inventions offers a superior selectivity as compared to other adsorbents.

TABLE 5

| | C₂H₆ | | C₂H₆/C₂H₄ | | |
|---|---|---|---|---|---|
| | capacity | C₂H₆/C₂H₄ | feed ratio | | |
| | (mmol/ | selectivity | for IAST | | |
| Adsorbent | [symbol] | (IAST) | [symbol] | Conditions | Reference DOI |
| 75CPDA | 7.1 | 2.5 | 1:15 | 298 K, 1 | 10.1002/aic.16182 |
| @A-AC | | | | bar | |
| [symbol] | | | | | |
| Beta-ZTC | 7.5 | 1.7 | 1:1 | 303 K, 1 | 10.1021/acsami.0c04228 |
| | | | | [symbol] | |
| FAU- | 4.5 | 1.5 | 1:1 | 303 K, 1 | 10.1021/acsami.0c04228 |
| [symbol] | | | | [symbol] | |
| EMT- | 6 | 1.6 | 1:1 | 303 K, 1 | 10.1021/acsami.0c04228 |
| [symbol] | | | | [symbol] | |
| C-PDA-3 | 9.41 | 1.9 | 1:9 | 298 K, 1 | 10.1016/j.ces.2016.08.026 |
| | | | | [symbol] | |
| Glc-A-4 | 7.98 | 1.7 | 1:1 | 288 K, 1 | 10.1016/j.ces.2017.07.020 |
| | | | | [symbol] | |
| MGA- | 7.1 | 2.3 | 1:15 | 298 K, 1 | 10.1016/j.cej.2018.10.109 |
| [symbol] | | | | bar | |
| C-Fru-4- | 7.9 | 1.6 | 1:1 | 298 K, 1 | 10.1016/j.jssc.2018.09.001 |
| 700 | | | | bar | |
| Kureha | 9.5 | 1.6 | 1:1 | 194 K, 1 | 10.1016/j.carbon.2005.01.010 |
| Carbon | | | | bar | |
| C-CTS-1 | 6.2 | 1.75 | 1:15 | 298 K, 1 | 10.1016/j.mtchem.2022.10 |
| | | | | [symbol] | [symbol] |
| G@700/2 | 13.24 | 1.2 | 1:1 | 298 K, 6 | 10.1016/j.colsurfa.2021.12 |
| | | | | [symbol] | |
| C-700-3 | 7.2 | 3.2 | 1:15 | 298 K, 6 | 10.1016/j.ces.2017.01.003 |
| | | | | [symbol] | |
| rGO-4-H | 1.17 | 3.8 | 1:15 | 298 K, 1 | First embodiment of the |
| | | | | bar | present invention |

[symbol]

indicates data missing or illegible when filed

### Example 19: Regenerability of Reduced Graphene Oxide (rGO)

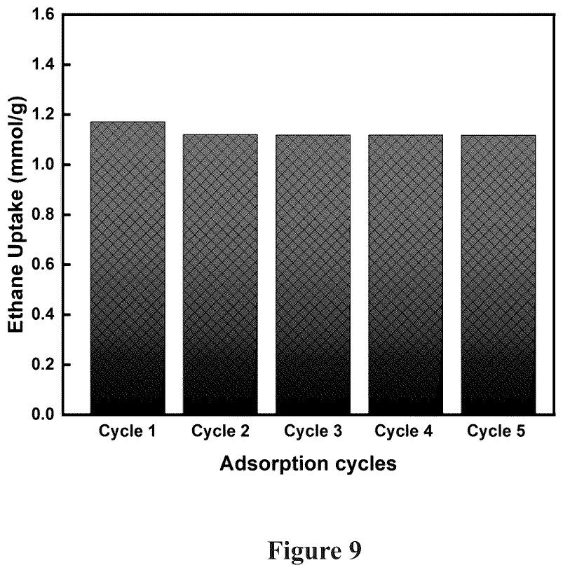

In this Example, repeated adsorption-desorption cycles were conducted at ambient conditions for the rGO-4-H adsorbent. The C₂H₆ capacity obtained at 1 bar for each cycle is illustrated in FIG. 9. Following each cycle, the adsorbent was not thermally regenerated and was only subject to vacuum cleaning until 10 mbar for desorption. After the first cycle, there was a slight reduction in C₂H₆ capacity from 1.17 to 1.12 mmol/g. Thereafter, there was no subsequent reduction in capacity after five cycles, revealing sustainable performance and energy-efficient regeneration of the adsorbents.

### Example 20: Molecular Interactions Between Reduced Graphene Oxide (rGO) Surface and Adsorbed Gas Molecules

In this Example, to evaluate molecular interactions between the rGO surface and the gas molecules and quantify van der Waal's forces, atomic force microscopy (AFM) was employed to understand the developed adsorbent/adsorbate nano-scale forces. Before the analysis, the silica-based antimony doped tips were coated with C₂H₆ and C₂H₄ molecules separately by exposing them to the respective gas streams at 25° C. for 6 h. The surface scanning was carried out at a scan rate of 0.99 Hz with a velocity of 5.95 μm/s, and the spring constant was estimated using a standard silica wafer.

C₂H₆ was perceived to exhibit enhanced van der Waal's interactions with a carbonaceous surface as a result of the higher polarizability of C₂H₆ (44.7×10⁻²⁵ cm³) compared to that of C₂H₄ (42.52×10⁻²⁵ cm³) mainly due to higher molecular weight. AFM used for force measurements (force spectroscopy) could retrieve the developed forces as a function of tip-sample separation distance (d). Accordingly, the force profile was mapped for the rGO-4-H sample with tips coated with C₂H₆ and C₂H₄ separately. The confirmation of the coating on the tips was achieved using FTIR spectra.

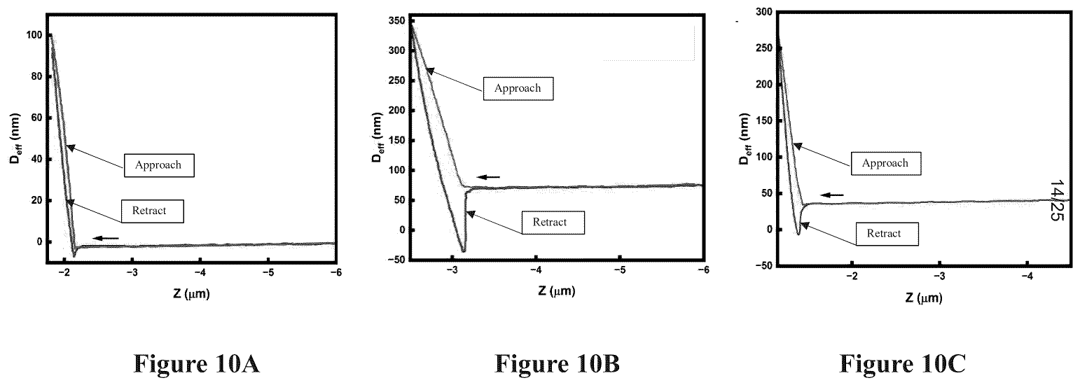

The force profile between the rGO-4-H surface and the tip was plotted as a function of deflection (Deff) of the cantilever and the distance between the tip and sample. Initially, a plain tip was used to plot the deflection curve, as shown in FIG. 10A. The lowest point in the retract curve is used to estimate the developed interaction force between the tip atoms/molecules and surface molecules at the point of contact by using Hooke's law. FIGS. 10B and 10C represent the deflection curves obtained with the tip exposed to C₂H₆ and C₂H₄, respectively. As evident from the curves, the maximum adsorption force was obtained for the tip exposed to the C₂H₆ gas. This supports the adsorption experimental results, establishing the selective C₂H₆ adsorption over C₂H₄ of the rGO samples.

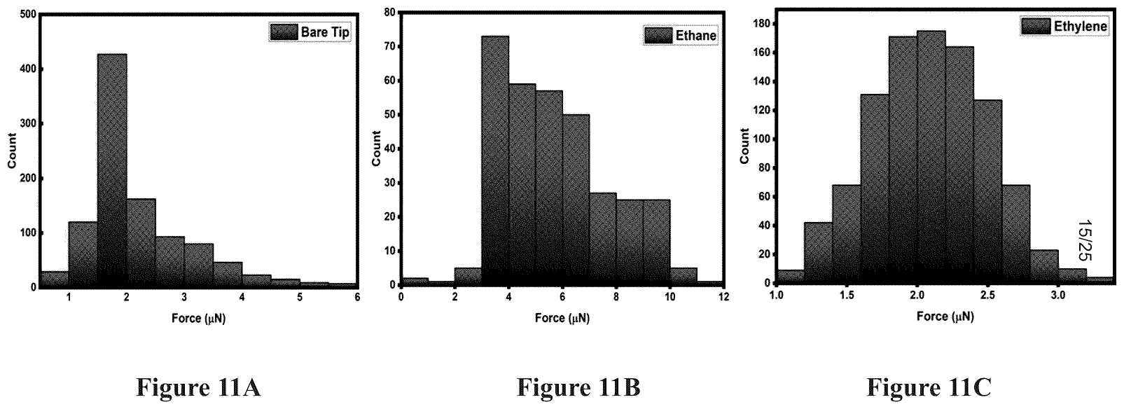

To further validate this conclusion, multiple spots on the sample surface were selected and force mapping was carried out. The average force for different spots across the surface was estimated using Gaussian approximation, and the corresponding histograms are shown in FIG. 11A-C. From the histograms and the relevant data, the mean force value obtained for the bare tip, tip exposed to C₂H₆, and tip exposed to C₂H₄ were 1.84 μN, 5.47 μN, and 2.08 μN, respectively. Evidently, the tip-sample interactions were higher for the C₂H₆-coated tip, quantifying and confirming the selective surface affinity with C₂H₆.

### Example 21: Breakthrough Tests for Reduced Graphene Oxide (rGO)

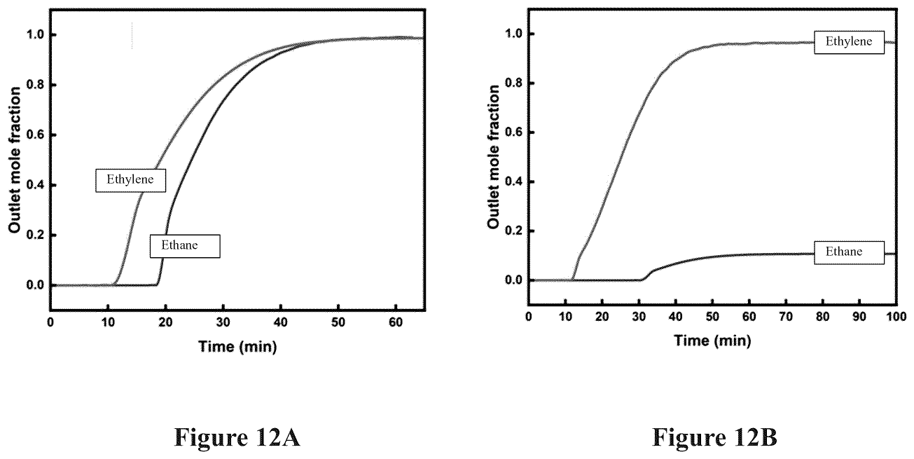

In this Example, and in order to evaluate the dynamic adsorption and separation performance of the rGO adsorbents, breakthrough experiments were also carried out with pure as well as binary real gas mixtures. FIGS. 12A and 12B shows the respective breakthrough curves for single gases and 1/9 (v/v) mixture of C₂H₆/C₂H₄ for the rGO-4-H adsorbent at 298 K and 1 bar. As demonstrated in the plot, there is a considerable time difference between the elution of the two gases. When the bed was purged with C₂H₄ gas alone, the breakthrough occurred at 10 min and reached saturation at 50 min. While purging with C₂H₆, gas was not detected in the outlet stream until 19 min. To examine the competitive adsorption behaviour, the feed was also switched to a 1/9 (v/v) real mixture of C₂H₆/C₂H₄. The time difference between the breakthrough of the two gases was 20 min, depicting the efficient selective adsorption of C₂H₆ in the packed bed. This observed time difference is great compared to the breakthrough time difference reported for most of the top-performing C₂H₆-selective adsorbents. In case of single gas breakthrough experiment, C₂H₆ eluted from the packed bed before C₂H₄ could reach complete saturation, whereas in case of real mixture breakthrough experiment, ample time difference between the breakthrough of two gases led C₂H₄ to reach a purity of at least 99.9% (based on the sensitivity of the DSMS gas analyser) before C₂H₆ started to leach out of the bed. This indicates the capability of the synthesized adsorbent in producing high purity C₂H₄ at ambient conditions of 298 K and 1 bar. The breakthrough working capacity was estimated from the mixture breakthrough curves and the C₂H₄ productivity calculated assuming a 99.9% purity, as a minimum value based on the sensitivity of the DSMS analyzer, from the breakthrough curves was 0.92 mmol/g for 1/9 mixture at 298 K and 1 bar. This estimated productivity is higher compared to the reported C₂H₄ productivities of 0.79, 0.72 and 0.28 mmol/g for other top-performing adsorbents. Similarly, the C₂H₆ productivity was found to be 0.21 mmol/g and accordingly for the 1/9 feed, the breakthrough selectivity was estimated to be 2.02, which is comparable with the breakthrough selectivity reported for other carbonaceous adsorbents. By utilizing C₂H₆-selective adsorbents, it is evident that the production of high purity C₂H₄ can be achieved through a simplified single-stage separation process.

Fluorine-functionalized Activated Carbon: The adsorption and separation performance tests for fluorine-functionalized activated carbon according to the second embodiment of the present invention are as follows (Examples 22-30):

The adsorbents (fluorine-functionalized activated carbon) were pre-treated at 100° C. for 12 h prior to the adsorption experiments. An automated breakthrough analyser (ABR) by Hiden Isochema was utilized to carry out the breakthrough experiments with C₂H₆/C₂H₄ mixtures. The reactor column (15 cm×1 cm) was filled with the pre-weighed samples of adsorbent and before each breakthrough run, helium was purged at a rate of 250 mL/min. Then a mixture of C₂H₆/C₂H₄ with a ratio of 1/9 (v/v) was passed at a rate of 5 mL/min while keeping the reactor conditions at 298 K and 1 bar. The composition of the mixture leaving the column was analyzed using a single-filter, electron multiplier dynamic sampling mass spectrometer (DSMS) by Hiden, with a detection range of 1-200 AMU and a sensitivity of 100 ppb.

### Example 22: Single-Component Equilibrium Adsorption of C₂H₆ and C₂H₄ on Pure Activated Carbon (AC)

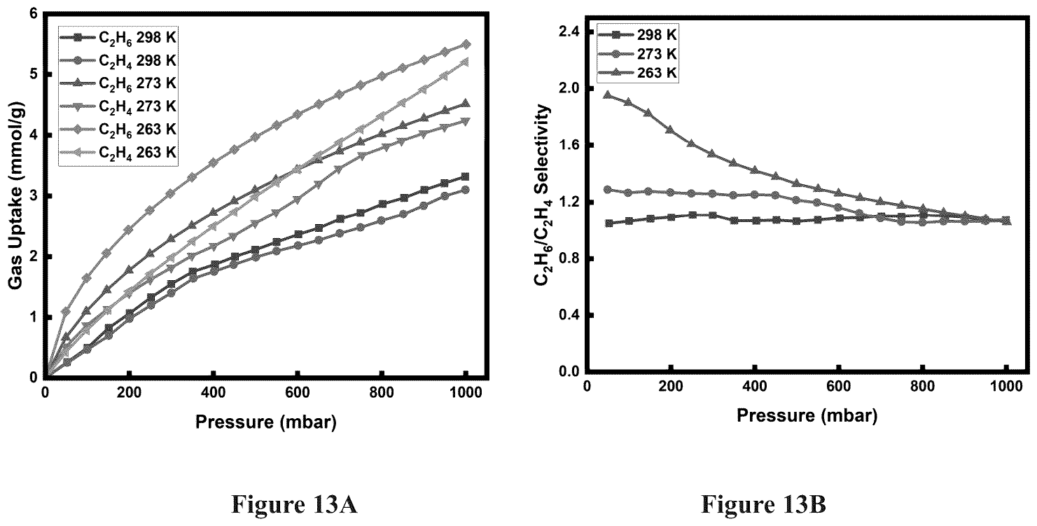

In this Example, the single-component equilibrium adsorption of C₂H₆ and C₂H₄ (gas uptake) on pure AC sample at various temperatures, namely 298, 273, and 263 K, and up to 1 bar. FIG. 13A-B illustrate the results of gas uptake and selectivity, respectively.

The results indicated that AC exhibited high gas adsorption capacity across all temperatures, which can be attributed to its high surface area and porosity, as verified by the N₂ isotherm analysis. At 298 and 273 K, despite the high gas uptakes, the C₂H₆ uptake was only slightly higher than that of C₂H₄. As a result, the experimental C₂H₆/C₂H₄ selectivity at 1 bar was 1.1 and 1.2, respectively, indicating a similar capacity for these two gases. At 263 K, the C₂H₆ uptake was substantially higher than that of C₂H₄ at the lower pressure range. Yet, as the pressure increased, the adsorption capacities of both gases became similar.

### Example 23: Single-Component Equilibrium Adsorption of C₂H₆ and C₂H₄ on Fluorine-Functionalized Activated Carbon

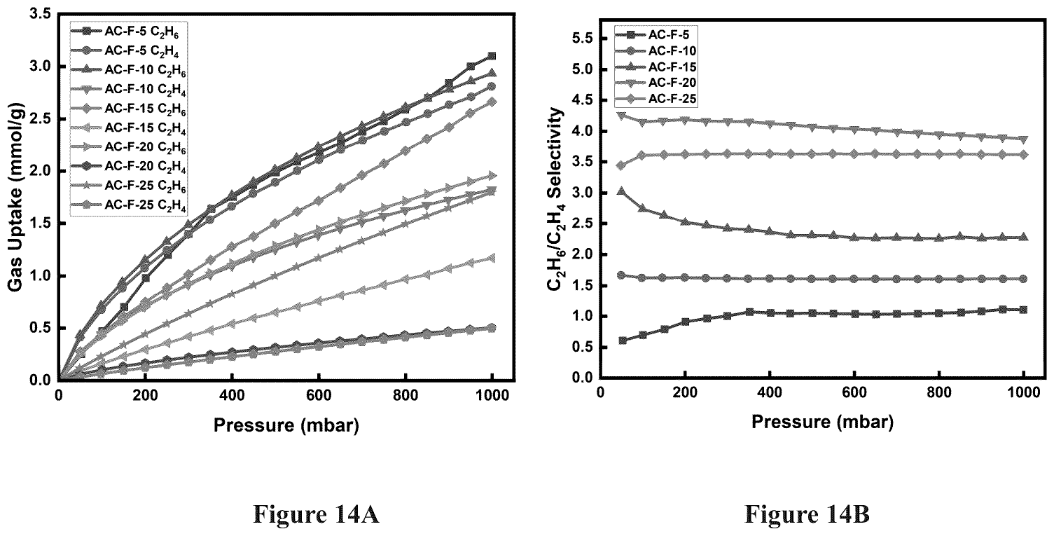

In this Example, same experiments as Example 22 were repeated with the only change that the adsorbent (activated carbon) is fluorine-functionalized as described earlier. FIG. 14A-B illustrate the results of gas uptake and selectivity, respectively.

FIG. 14A shows the adsorption isotherms of all fluorine-functionalized AC samples at 298 K and up to 1 bar. AC-F-5, which was the adsorbent with the lowest fluorine loading, exhibits a C₂H₆ capacity of 3.1 mmol/g which was reduced to 2.9, 2.66, 1.95, and 1.79 for AC-F-10, AC-F-15, AC-F-20, and AC-F-25 respectively, demonstrating a gradual decline of gas uptake with an increase in fluorine content. This trend is attributed to the reduction in the adsorbent surface area as observed from the N₂ isotherms discussed above. In contrast to the gas capacity, the experimental selectivity followed the opposite trend, i.e., it increased steadily from 1.1 at 1 bar for AC-F-5 to 3.9 for AC-F-20, as shown in FIG. 14B, owing to the increasing density of the functional agents on the surface. Afterwards, it stabilized and decreased slightly to 3.6 for AC-F-25, which is attributed to the fact that over-dosing of functional agents on the surface will not further increase the specific sites, rather it decreased the effective surface areas for adsorption and lead to a decrease in selectivity for AC-F-25. Fluorine-doping resulted in a significant increase in experimental C₂H₆/C₂H₄ selectivity (from 1.1 on pure AC to 3.9 on AC-F-20 at 298 K and 1 bar), due to the C—H . . . F interactions between the C₂H₆ molecules and the fluorine atoms present on the surface. Indeed, C₂H₆ can form six such hydrogen bonds compared to four of C₂H₄, and these interactions were found to be crucial in enhancing the C₂H₆ selectivity.

### Example 24: Effect of Temperature on Performance of Fluorine-Functionalized Activated Carbon

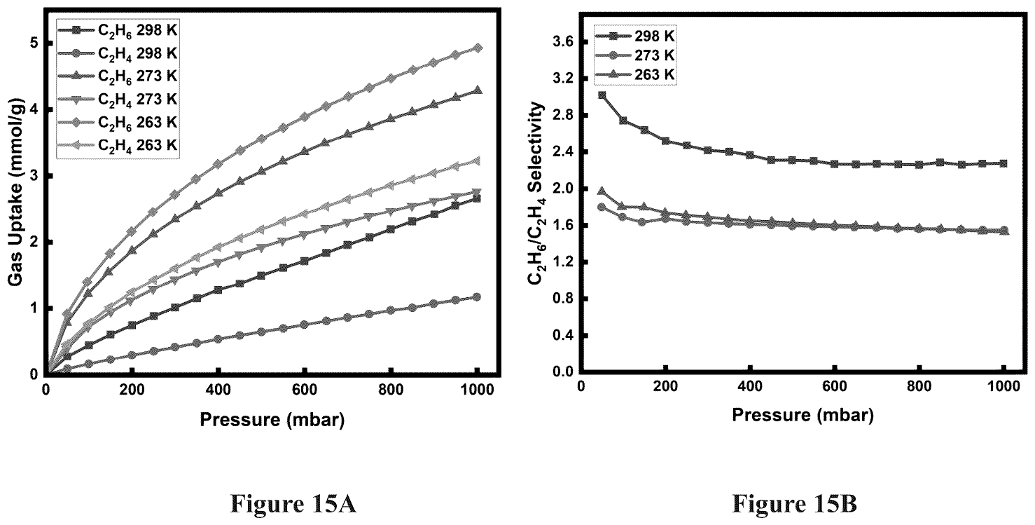

Based on Examples 22 and 23, two optimal samples (AC-F-15 and AC-F-20) with notable selectivity and capacity were subject to further investigation. AC-F-15 demonstrated a C₂H₆ uptake of 2.7 mmol/g at 298 K and 1 bar, as shown in FIG. 15A, which compared favourably to the C₂H₄ uptake of 1.2 mmol/g at the same conditions. For AC-F-15, with a decrease in temperature, the C₂H₆ uptake at 1 bar increased (4.3 and 4.9 mmol/g at 273 K and 263 K, respectively) indicating that physisorption is the main governing mechanism of adsorption in the modified samples. Similarly, C₂H₄ uptake increased to 2.7 and 3.2 mmol/g at the same conditions. As for selectivity (FIG. 15B), the highest selectivity of 2.8 at 50 mbar was observed at 298 K, while at 273 and 263 K, a selectivity of 1.5 was attained at 1 bar. At lower temperatures, partial condensation of the hydrocarbon gases in small pores occurs, resulting in suppression of the specific interactions between the adsorbent surface and C₂H₆ molecules.

### Example 25: Ideal Adsorbed Solution Theory (IAST) Selectivity Estimated for the AC-F-15

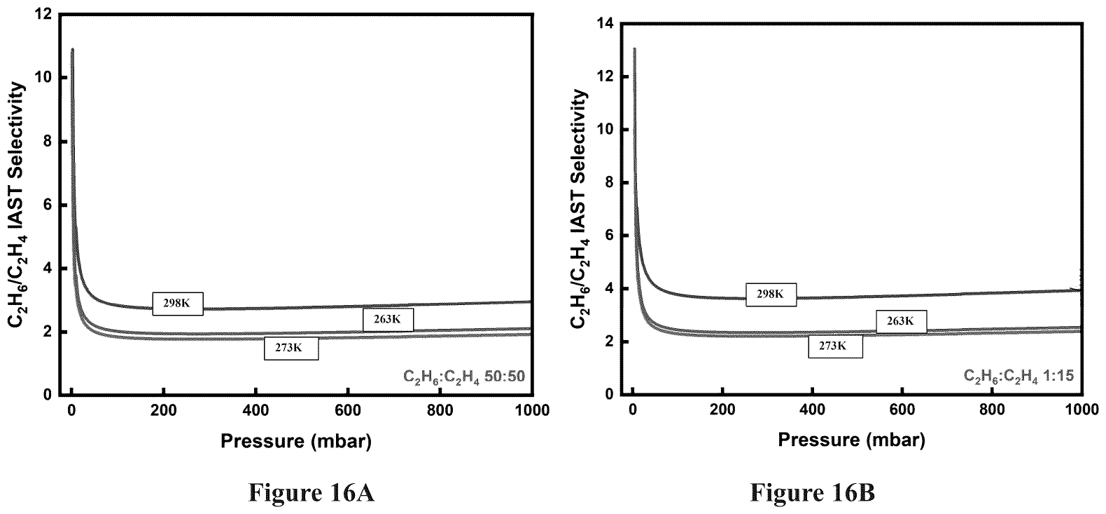

In this Example, the ideal adsorbed solution theory (IAST) selectivity was estimated, as had been described above, for the AC-F-15 adsorbent at different temperatures (298, 273, and 263 K) for two different feed ratios, namely, 50/50 (v/v) C₂H₆/C₂H₄ and 1/15 (v/v) C₂H₆/C₂H₄ which is the composition of C₂H₆/C₂H₄ industrial feed after naphtha cracking. The results are illustrated in FIGS. 16A-B.

It is seen that, for the 50/50 mixture, AC-F-15 had a remarkable C₂H₆/C₂H₄ selectivity of 5 at 10 mbar and T=298K, which then reached a steady value of 2.9 at 100 mbar and up to 1 bar. For the 1/15 mixture, the C₂H₆/C₂H₄ selectivity increased to 4 at 298 K and 1 bar, which is much higher than most of the C₂H₆-selective adsorbents. At the lower temperatures for the 1/15 mixture, specifically 273 and 263 K, the C₂H₆/C₂H₄ selectivity reduced to 2.38 and 2.54, respectively, at 1 bar.

### Example 26: Adsorption Capacity and Selectivity for the AC-F-20

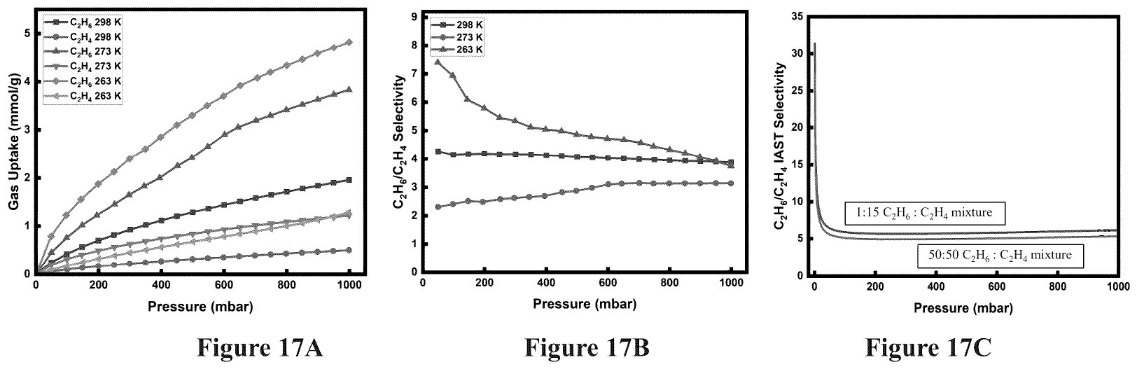

In this Example, given that that in the separation of industrial C₂H₆/C₂H₄ streams selectivity plays a more crucial role than the capacity in meeting the standards of C₂H₄ purity, the adsorbent with notable selectivity (AC-F-20) and capacity was tested for adsorption performance at different temperatures. The results are illustrated in FIGS. 17A-C.

Both C₂H₆ and C₂H₄ uptakes increased with a decrease in temperature. For C₂H₆, the uptake increased from 1.96 at 298 K to 3.83 and 4.82 mmol/g at 273 and 263 K, respectively, at 1 bar, whereas the respective increment in C₂H₄ uptake was only from 0.5 to 1.3 mmol/g (FIG. 17A). As a result, AC-F-20 exhibited an outstanding selectivity of 7.4 at 50 mbar and 263 K, while at higher pressures, the selectivity reached a steady value of 4, which is almost the same as the selectivity at 298 K at this pressure (FIG. 17B). The porous adsorption sites based on van der Waal's interactions (site-1) are non-specific sites allowing for multilayer physical adsorption, whereas fluorine-doped sites (site-2) are specific single layer adsorption sites. Thus, at low pressure, the adsorption on site-2 seemed to be dominant with high selectivity; while at high pressure, adsorption on site-1 takes over. Furthermore, the IAST selectivity determined for two different feed mixtures is shown in FIG. 17C. AC-F-20 exhibited a superior selectivity of 6.1 at 298 K and 1 bar, which was the highest at these conditions among all the fluorine-doped adsorbents in the present disclosure. At the lower pressure range, the selectivity reached a value of 10 at 10 mbar.

### Example 27: Adsorption Performance Based on Fluorine-Functionalization

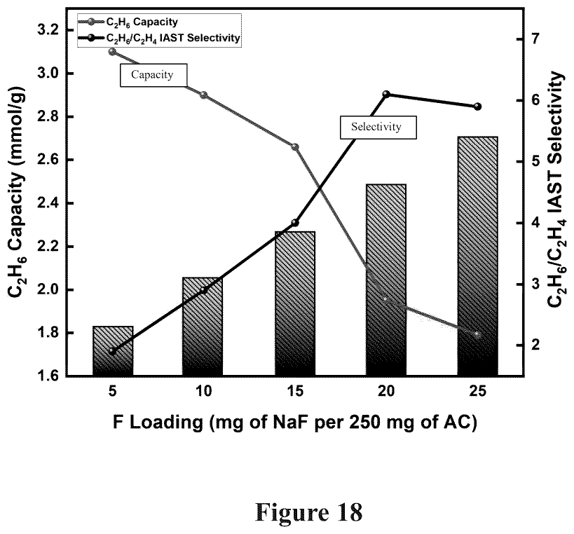

In this Example, the performance of adsorbents with varying levels of fluorine functionalization was determined in terms of their C₂H₆ capacity and C₂H₆/C₂H₄ IAST selectivity. The gas stream was a binary mixture of C₂H₆/C₂H₄ with a ratio of 1/15 (v/v) at 1 bar and 298 K. The results are illustrated in FIG. 18.

From FIG. 18, the selectivity varied from 1.9 to 6.1 with increase in fluorine loading, with a corresponding decrease in C₂H₆ capacity. For instance, the sample with the highest selectivity of 6.1 (AC-F-20) had the C₂H₆ capacity of 1.95 mmol/g. From this plot, selection of the appropriate adsorbent can be made according to the application targets. For example, AC-F-15 was found to maintain an optimum balance between selectivity and capacity, while AC-F-20, exhibits a significantly higher selectivity with a relatively low capacity, thus it should be preferred for applications where very high purity of the produced ethylene is required.

### Example 28: Regenerability of Fluorine-Functionalized Activated Carbon as Adsorbent

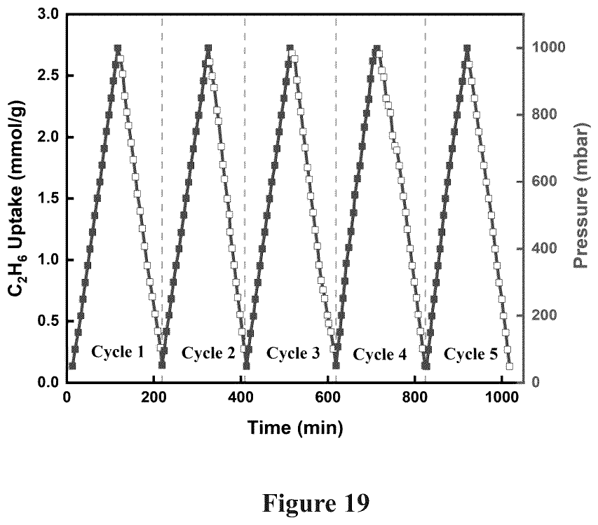

In this Example, adsorption-desorption cycles were conducted to evaluate the cyclic performance of the adsorbents, investigated via pressure-swing adsorption (PSA). Five PSA cycles were performed without any thermal-treatment between the cycles. FIG. 19 shows the cyclic performance AC-F-15 at 298 K and up to 1 bar. Evidently, after five cycles, there was no decline in the capacity of the adsorbent, with a constant C₂H₆ uptake of 2.66 mmol/g. Notably, such a sizeable amount of C₂H₆ was almost completely desorbed from the adsorbent by pressure swing alone. Such facile and energy-efficient regeneration at ambient temperature highlights the potential of the developed functionalized adsorbents for industrial application.

### Example 29: Moisture Stability of Fluorine-Functionalized Activated Carbon as Adsorbent

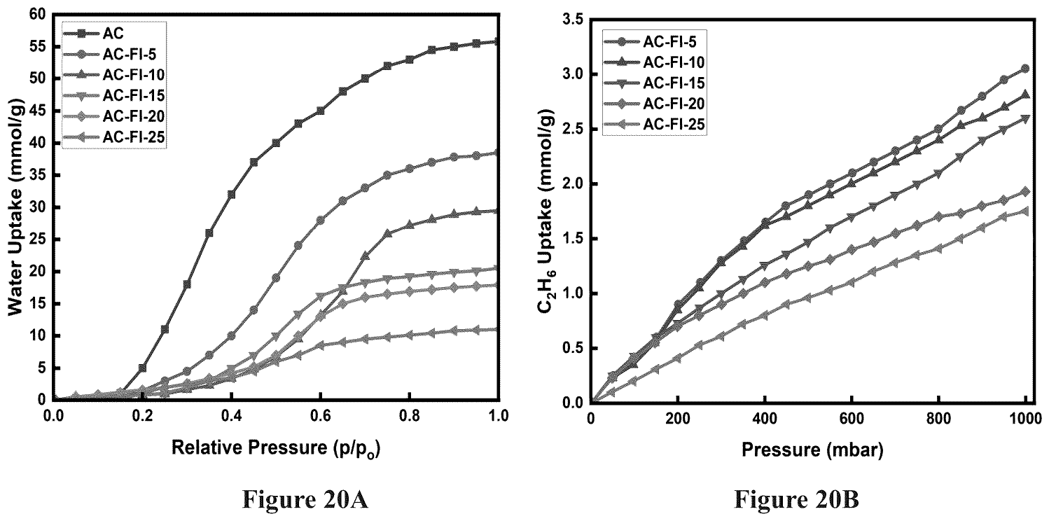

In this Example, water vapor sorption experiments were carried out at 298 K and up to 100% relative humidity (RH). In addition, the moisture-exposed samples were tested for C₂H₆ adsorption. The water vapor isotherms in FIG. 20A show a systematic suppression of the hydrophilicity of the adsorbents with the increase in fluorine doping. Indeed, pure AC had the highest water uptake (maximum of 56 mmol/g), which gradually decreased to 11 mmol/g for AC-F-25. i.e., undergoing a 5-fold reduction in water uptake. This drop in moisture uptake is corroborated by the degree of functionalization and the reduction in surface area as confirmed above by porosimetry. Fluorine is well known for its hydrophobicity when bonded to carbon, due to the fact that its strong electronegativity can draw the shared electrons and reduce the polarity of the neighbouring atoms and subsequently weaken the interaction between the carbon surface and water, resulting in reduced wettability. The moisture-exposed fluorine-doped samples were then tested for C₂H₆ adsorption at 298 K. The obtained C₂H₆ adsorption isotherms of the pre-humidified adsorbents are shown in FIG. 20B. A minor decrease in C₂H₆ uptake was observed, i.e. by 1.6, 4, 2.2, 1.3, and 2.6% for AC-F-5, AC-F-10, AC-F-15, AC-F-20, and AC-F-25, respectively, indicating that the C₂H₆ adsorption capacity was not significantly affected by the moisture content.

### Example 30: Breakthrough Analysis of Fluorine-Functionalized Activated Carbon as Adsorbent

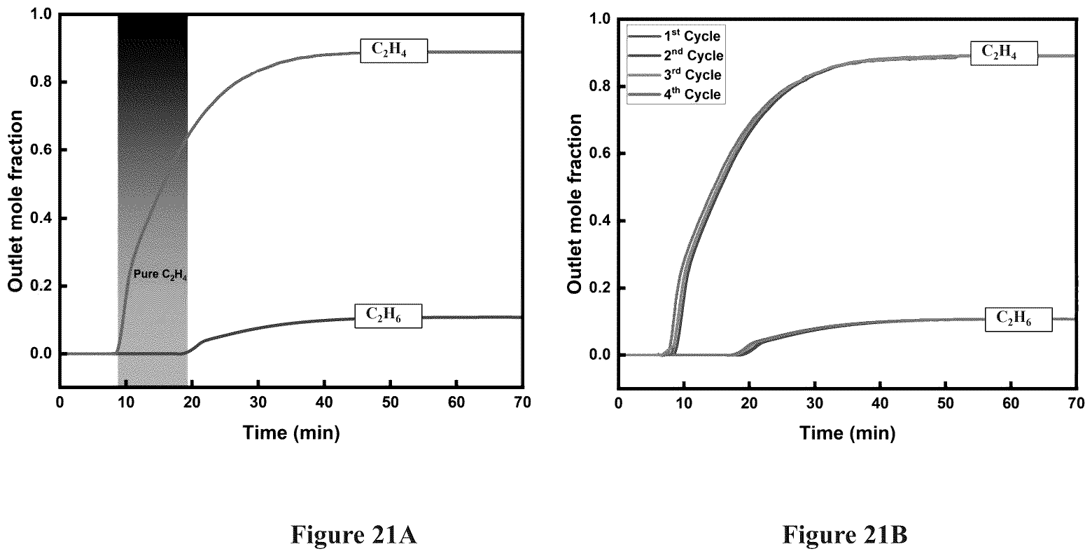

In this Example, breakthrough experiments on AC-F-15 were carried out on a fixed bed (15 cm^{×1} cm) with a stream of C₂H₆/C₂H₄ mixture in a ratio of 1/9 (v/v) as the feed, at ambient conditions. Cyclic experiments were conducted to evaluate the separation performance of the adsorbent. From the breakthrough curves (FIG. 21A), C₂H₄ was eluted out of the bed after 7 min, indicating the selective adsorption of C₂H₆ by the packed bed. C₂H₆ breaks through at 18 min, i.e., with a time difference of 11 min between the two gases, thus enabling sufficient processing time for the production of polymer-grade C₂H₄. This breakthrough time gap between the two gases is higher than some of the best-performing C₂H₆-selective adsorbents reported in literature.

Subsequently, multi-cycle breakthrough experiments were carried out without any thermal regeneration of the adsorbent bed in between the cycles. After every cycle helium was purged for 20 min at 298 K for regenerating the bed. These cyclic experiments (with results in FIG. 21B) showed that the time difference between the elution of C₂H₆ and C₂H₄ remain almost unchanged for four cycles, confirming the high cyclable performance of the adsorbent. The results of these experiments demonstrate that the developed C₂H₆-selective adsorbents can efficiently produce polymer-grade (99.99%) C₂H₄ through a single-step adsorption process without involvement of thermal regeneration.

It would be apparent to the person skilled in the art that while the drawings in the present disclosure have illustrated a packing list envelope with a rectangular geometry, other non-rectangular geometries could also be envisioned without departing from the spirit of the present invention.

All publications described or referred to, are incorporated herein by reference.

1. A carbon-based adsorbent for separation and removal of light paraffins from light paraffins/olefins mixtures that substantially comprises light olefins and at ambient/normal conditions of temperature and pressure, the carbon-based adsorbent comprising a carbonaceous based material functionalized at least in part on active sites thereof with functional groups configured to selectively adsorb the light paraffins from the mixture, thereby resulting in a purity of at least 99.9% of the light olefins upon separation.

2. The adsorbent according to claim 1, wherein the carbon-based adsorbent is configured to be used for the separation of light paraffins from the light paraffins/olefins mixture at a temperature ranging from about 263 K to about 298 K and at a pressure of up to about 1 bar, at about 298 K and 1 bar so that extra energy is not required for heating/cooling and/or compression/decompression.

3. The adsorbent according to claim 1, wherein the adsorbent has a kinetic selectivity of about 2.4 at 298 K and 1 bar.

4. The adsorbent according to claim 1, wherein the adsorbent has an IAST selectivity ranging from about 2.38 to about 6.1 at 298 K and 1 bar.

5. The adsorbent according to claim 1, wherein the adsorbent has a breakthrough selectivity ranging from about 2 to about 2.64 at 298 K and 1 bar.

6. The adsorbent according to claim 1, wherein the adsorbent has a paraffin adsorption capacity ranging from about 1.17 mmol/g to about 3.1 mmol/g at 298 K and 1 bar.

7. The adsorbent according to claim 1, wherein the carbonaceous base comprises reduced graphene oxide, or the carbonaceous base comprises activated carbon and the functional groups comprise fluorine.

8. The adsorbent according to claim 1, wherein the light paraffins are ethane and the light olefins are ethylene.

9. The adsorbent according to claim 1, wherein the adsorbent is regenerable.

10. The adsorbent according to claim 9, wherein the adsorbent allows for multiple regeneration cycles while maintaining substantially a same adsorption capacity, wherein the multiple regeneration cycles are performed via vacuum in the absence of thermal energy input, or at ambient pressure by purging with inert gas.

11. An activated carbon based adsorbent for separation and removal of light paraffins from a light paraffins/olefins mixture that substantially comprises the light olefins at ambient/normal conditions of temperature and pressure, the adsorbent comprising activated carbon functionalized at least in part on active sites thereof with fluorine functional groups, wherein the adsorbent is configured to selectively adsorb the light paraffins from the mixture thereby resulting in a purity of at least 99.9% of the light olefins upon separation.

12. The adsorbent according to claim 11, wherein the carbon-based adsorbent is configured to be used for the separation of the light paraffins from the light paraffins/olefins mixture at a temperature range from about 263 K to about 298 K and at a pressure of about 1 bar, so that extra energy is not required for heating/cooling and/or compression/decompression.

13. The adsorbent according to claim 11, wherein the adsorbent has a BET surface area ranging from about 448 m²/g to about 1220 m²/g.

14. The adsorbent according to claim 11, wherein the adsorbent has a total pore volume from about 0.44 cm³/g to about 0.79 cm³/g.

15. The adsorbent according to claim 11, wherein the adsorbent has an average pore size from about 2.58 nm to about 3.95 nm.

16. The adsorbent according to claim 11, wherein the adsorbent has a light paraffins adsorption capacity ranging from about 1.79 mmol/g of adsorbent to about 3.1 mmol/g of adsorbent at 298 K and 1 bar.

17. The adsorbent according to claim 11, wherein the adsorbent has a selectivity ranging from about 1.1 to about 3.9 at 298 K and 1 bar.

18. The adsorbent according to claim 11, wherein the adsorbent has an IAST selectivity ranging from about 2 to about 6.1 at ambient conditions of about 298 K and about 1 bar for the light paraffins/olefins mixture having a volumetric ratio of 1:15.

19. The adsorbent according to claim 11, wherein the adsorbent has a breakthrough selectivity of about 2.64 at 298 K and 1 bar for the light paraffins/olefins mixture having a volumetric ratio of 1:9.

20. The adsorbent according to claim 11, wherein the adsorbent has a kinetic selectivity of about 2.4 at 298 K and 1 bar.

21. The adsorbent according to claim 11, wherein the light paraffins are ethane and the light olefins are ethylene.

22. A method of manufacturing an activated carbon based adsorbent for separating light from a light paraffins/olefins mixture that substantially comprises light olefins, the method comprising:
mixing a given amount of activated carbon with an acidic solution comprising a given amount of sodium fluoride to obtain a biphasic mixture wherein a mass ratio of the activated carbon to the sodium fluoride ranges from about 10 to about 50;
filtering the biphasic mixture to obtain a solid phase;
washing the solid phase;
drying the solid phase; and
heating the dried solid phase under inert atmosphere to obtain the activated carbon based adsorbent.

23. The method of claim 22, wherein the mixing is performed by sonication, for about 30 min.

24. The method of claim 22, wherein the washing step is performed with an aqueous solution comprising water, DI water and more DI water and ethanol.

25. The method of claim 22, wherein the drying step is performed at a temperature of about 80° C.

26. The method of claim 22, wherein the heating step is performed under inert gas atmosphere at 300° C., for about 2 hours.

27. A carbon based adsorbent for separation of light paraffins from a light paraffins/olefins mixture that substantially comprises the light olefins at ambient/normal conditions of temperature and pressure, the adsorbent comprising reduced graphene oxide having at least in part on active sites thereof oxygen groups configured to selectively adsorb the light paraffins from the mixture thereby resulting in a purity of at least 99.9% of the light olefins upon separation.

28. The adsorbent according to claim 27, wherein the carbon-based adsorbent is configured to be used for the separation of the light paraffins from a light paraffins/olefins mixture at a temperature range from about 263 K to about 298 K and a pressure of about 1 bar, at about 298 K and about 1 bar so that extra energy is not required for heating/cooling and/or compression/decompression.

29. The adsorbent according to claim 27, wherein the adsorbent has a light paraffins capacity of 1.17 mmol/g of adsorbent at 298 K and 1 bar.

30. The adsorbent according to claim 27, wherein the adsorbent has a selectivity of about 1.6 at 298 K and 1 bar.

31. The adsorbent according to claim 27, wherein the adsorbent has a kinetic selectivity of about 2.4 at 298 K and 1 bar.

32. The adsorbent according to claim 27, wherein the adsorbent has an IAST selectivity of about 3.8 at 298 K and 1 bar for the light paraffins/olefins mixture having a volumetric ratio of 1:15.

33. The adsorbent according to claim 27, wherein the adsorbent has a breakthrough selectivity of about 2 at 298 K and 1 bar for the light paraffins/olefins mixture having a volumetric ratio of 1:9.

34. The adsorbent according to claim 27, wherein the light paraffins are ethane and the light olefins are ethylene.

35. A method of manufacturing an adsorbent for separation of light paraffins from a light paraffins/olefins mixture that substantially comprises the light olefins, the method comprising:
preparing or providing a given amount of graphene oxide;
mixing the given amount of graphene oxide with water thereby obtaining a graphene oxide suspension;
adding a given volume of a reducing agent to the graphene oxide suspension to obtain a mixture; and
heating the mixture under pressure in the presence of reducing agents to obtain reduced graphene oxide forming the adsorbent.

36. The method according to claim 35, wherein a ratio of reducing agent to the mass of graphene oxide is about 1 μl/3 mg.

37. The method according to claim 35, wherein the reducing agent is selected from the group consisting of hydrazine hydrate, ethylene glycol and ethylene diamine, hydrazine hydrate.

38. The method of claim 35, wherein the heating step is performed under autogenous pressure in the presence of the reducing agents at 160° C., for about 4 hours.
